(19) United States
(12) Patent Application Publication
(10) Pub. No.: US 2026/0046067 A1
(43) Pub. Date: Feb. 12, 2026

(54) METHOD, USER EQUIPMENT, AND PROCESSING DEVICE FOR TRANSMITTING UPLINK SIGNAL, STORAGE MEDIUM, AND METHOD AND BASE STATION FOR RECEIVING UPLINK SIGNAL

(71) Applicant: LG ELECTRONICS INC., Seoul (KR)

(72) Inventors: Duckhyun BAE, Seoul (KR); Youngdae LEE, Seoul (KR); Suckchel YANG, Seoul (KR); Seonwook KIM, Seoul (KR)

(21) Appl. No.: 19/102,742

(22) PCT Filed: Aug. 11, 2023
(86) PCT No.: PCT/KR2023/011934

§ 371 Date: Feb. 10, 2025

Related U.S. Application Data
(60) Provisional application No. 63/397,377, filed on Aug. 11, 2022.
(60) Provisional application No. 63/411,603, filed on Sep. 29, 2022.

(30) Foreign Application Priority Data
Nov. 4, 2022 (KR) 10-2022-0146524

(51) Int. Cl. H04L 1/08; H04L 5/00; H04W 72/232

(52) U.S. Cl. CPC H04L 1/08; H04L 5/0078; H04W 72/232

(57) ABSTRACT

This UE can: transmit, on the basis of a configured grant, a physical uplink shared channel (PUSCH) including a transport block; and determine, on the basis of whether a packet delay budget of the transport block has expired, whether retransmission is performed according to a downlink control information (DCI) format if the DCI format related to the transport block is received.

### CROSS-REFERENCE TO RELATED APPLICATIONS

This application is a National Phase application under 35 U.S.C. 371 of International Application No. PCT/KR2023/011934, filed on Aug. 11, 2023, which claims the benefit of U.S. Provisional Application No. 63/397,377, filed on Aug. 11, 2022, U.S. Provisional Application No. 63/411,603, filed on Sep. 29, 2022, and Korean Patent Application No. 10-2022-0146524, filed on Nov. 4, 2022, the contents of which are incorporated by reference herein in their entirety.

### TECHNICAL FIELD

The present disclosure relates to a wireless communication system.

### BACKGROUND

A variety of technologies, such as machine-to-machine (M2M) communication, machine type communication (MTC), and a variety of devices demanding high data throughput, such as smartphones and tablet personal computers (PCs), have emerged and spread. Accordingly, the volume of data throughput demanded to be processed in a cellular network has rapidly increased. In order to satisfy such rapidly increasing data throughput, carrier aggregation technology or cognitive radio technology for efficiently employing more frequency bands and multiple input multiple output (MIMO) technology or multi-base station (BS) cooperation technology for raising data capacity transmitted on limited frequency resources have been developed.

As more and more communication devices have required greater communication capacity, there has been a need for enhanced mobile broadband (eMBB) communication relative to legacy radio access technology (RAT). In addition, massive machine type communication (mMTC) for providing various services at anytime and anywhere by connecting a plurality of devices and objects to each other is one main issue to be considered in next-generation communication.

Communication system design considering services/user equipment (UEs) sensitive to reliability and latency is also under discussion. The introduction of next-generation RAT is being discussed in consideration of eMBB communication, mMTC, ultra-reliable and low-latency communication (URLLC), and the like.

### SUMMARY

A method of efficiently transmitting data packets in which jitter may occur in a wireless communication system is needed.

Additionally, a method of timely providing resource allocation to a user equipment (UE) is needed.

A processing method for scheduling in consideration of a packet delay budget of data is required.

A method of activating/deactivating a plurality of semi-static configurations is required.

The objects to be achieved with the present disclosure are not limited to what has been particularly described hereinabove and other objects not described herein will be more clearly understood by persons skilled in the art from the following detailed description.

According to an aspect of the present disclosure, a method of transmitting an uplink (UL) signal by a user equipment (UE) in a wireless communication system is provided. The method may include receiving a configured grant configuration for a configured grant, performing physical uplink shared channel (PUSCH) transmission including a transport block based on the configured grant, receiving downlink control information (DCI format) related to the transport block, and determining whether to perform retransmission according to the DCI format based on whether a packet delay budget of the transport block expires.

According to another aspect of the present disclosure, a UE for transmitting a UL signal in a wireless communication system is provided. The UE includes at least one transceiver, at least one processor, and at least one computer memory operably connected to the at least one processor and storing instructions that, when executed, cause the at least one processor to perform operations. The operations may include receiving a configured grant configuration for a configured grant, performing physical uplink shared channel (PUSCH) transmission including a transport block based on the configured grant, receiving downlink control information (DCI format) related to the transport block, and determining whether to perform retransmission according to the DCI format based on whether a packet delay budget of the transport block expires.

According to another aspect of the present disclosure, a processing device is provided. The processing device includes at least one processor, and at least one computer memory operably connected to the at least one processor and storing instructions that, when executed, cause the at least one processor to perform operations. The operations may include receiving a configured grant configuration for a configured grant, performing physical uplink shared channel (PUSCH) transmission including a transport block based on the configured grant, receiving downlink control information (DCI format) related to the transport block, and determining whether to perform retransmission according to the DCI format based on whether a packet delay budget of the transport block expires.

According to another aspect of the present disclosure, a computer-readable storage medium is provided. The storage medium may store at least one processor code including instructions that, when executed, cause at least one processor to perform operations, and the operations may include receiving a configured grant configuration for a configured grant, performing physical uplink shared channel (PUSCH) transmission including a transport block based on the configured grant, receiving downlink control information (DCI format) related to the transport block; and determining whether to perform retransmission according to the DCI format based on whether a packet delay budget of the transport block expires.

According to another aspect of the present disclosure, a method of receiving a UL signal from a UE by a BS in a wireless communication system is provided. The method may include transmitting a configured grant configuration for a configured grant, performing physical uplink shared channel (PUSCH) reception including a transport block based on the configured grant, transmitting downlink control information (DCI format) related to retransmission of the transport block, and wherein, based on whether a packet delay budget of the transport block expires, the retransmission of the transport block is received or not received in a time-frequency resource according to the DCI format.

According to another aspect of the present disclosure, a BS for receiving a UL signal from a UE in a wireless communication system is provided. The BS includes at least one transceiver, at least one processor, and at least one computer memory operably connected to the at least one processor and storing instructions that, when executed, cause the at least one processor to perform operations. The operations may include transmitting a configured grant configuration for a configured grant, performing physical uplink shared channel (PUSCH) reception including a transport block based on the configured grant, and transmitting downlink control information (DCI format) related to retransmission of the transport block, wherein, based on whether a packet delay budget of the transport block expires, the retransmission of the transport block may be received or not received in a time-frequency resource according to the DCI format.

According to each aspect of the present disclosure, the method may further include performing retransmission for the transport block by using a UL grant included in the DCI format based on that the packet delay budget of the transport block does not expire.

According to each aspect of the present disclosure, the method may further include disregarding the DCI format based on that the packet delay budget of the transport block expires.

According to each aspect of the present disclosure, the method may further include determining a length of a configured grant timer for the configured grant based on the packet delay budget of the transport block, and starting the configured grant timer based on performing the PUSCH transmission including the transport block.

According to each aspect of the present disclosure, the determining of the length of the configured grant timer may include determining a remaining packet delay budget of the transport block as the length of the configured grant timer.

According to each aspect of the present disclosure, the method may further include determining whether the packet delay budget of the transport block expires based on that the configured grant timer expires.

The foregoing solutions are merely a part of the examples of the present disclosure and various examples into which the technical features of the present disclosure are incorporated may be derived and understood by persons skilled in the art from the following detailed description.

According to some implementations of the present disclosure, resource allocation may be provided to a user equipment (UE) in a timely manner.

According to some implementations of the present disclosure, appropriate radio resources may be allocated to traffic that needs to be transmitted.

According to some implementations of the present disclosure, scheduling may be treated differently depending on a packet delay budget of data.

According to some implementations of the present disclosure, activation/deactivation related to a plurality of semi-static configurations may be performed.

According to some implementations of the present disclosure, delay/latency that occurs during wireless communication between communication devices may be reduced.

The effects according to the present disclosure are not limited to what has been particularly described hereinabove and other effects not described herein will be more clearly understood by persons skilled in the art related to the present disclosure from the following detailed description.

### BRIEF DESCRIPTION OF THE DRAWINGS

The accompanying drawings, which are included to provide a further understanding of the present disclosure, illustrate examples of implementations of the present disclosure and together with the detailed description serve to explain implementations of the present disclosure:

FIG. 1 illustrates an example of a communication system 1 to which implementations of the present disclosure are applied;

FIG. 2 is a block diagram illustrating examples of communication devices capable of performing a method according to the present disclosure;

FIG. 3 illustrates another example of a wireless device capable of performing implementation(s) of the present disclosure;

FIG. 4 illustrates an example of a frame structure used in a 3rd generation partnership project (3GPP)-based wireless communication system;

FIG. 5 illustrates a resource grid of a slot;

FIG. 6 illustrates an example of physical downlink shared channel (PDSCH) time domain resource assignment (TDRA) caused by a physical downlink control channel (PDCCH) and an example of physical uplink shared channel (PUSCH) TDRA caused by the PDCCH;

FIG. 7 illustrates a hybrid automatic repeat request-acknowledgement (HARQ-ACK) transmission/reception procedure;

FIG. 8 illustrates a flow of a user equipment (UE) operation to which some implementations of the present disclosure are applicable;

FIG. 9 illustrates a flow of a base station (BS) operation to which some implementations of the present disclosure are applicable;

FIGS. 10 and 11 illustrate packet delay budget (PDB)-based retransmission related operations according to some implementations of the present disclosure;

FIG. 12 illustrates a CG timer according to some implementations of the present disclosure;

FIG. 13 illustrates a flow of UL signal transmission at a UE according to some implementations of the present disclosure; and

FIG. 14 illustrates a flow of UL signal reception at a BS according to some implementations of the present disclosure.

### DETAILED DESCRIPTION

Hereinafter, implementations according to the present disclosure will be described in detail with reference to the accompanying drawings. The detailed description, which will be given below with reference to the accompanying drawings, is intended to explain exemplary implementations of the present disclosure, rather than to show the only implementations that may be implemented according to the present disclosure. The following detailed description includes specific details in order to provide a thorough understanding of the present disclosure. However, it will be apparent to those skilled in the art that the present disclosure may be practiced without such specific details.

In some instances, known structures and devices may be omitted or may be shown in block diagram form, focusing on important features of the structures and devices, so as not to obscure the concept of the present disclosure. The same reference numbers will be used throughout the present disclosure to refer to the same or like parts.

A technique, a device, and a system described below may be applied to a variety of wireless multiple access systems. The multiple access systems may include, for example, a code division multiple access (CDMA) system, a frequency division multiple access (FDMA) system, a time division multiple access (TDMA) system, an orthogonal frequency division multiple access (OFDMA) system, a single-carrier frequency division multiple access (SC-FDMA) system, a multi-carrier frequency division multiple access (MC-FDMA) system, etc. CDMA may be implemented by radio technology such as universal terrestrial radio access (UTRA) or CDMA2000. TDMA may be implemented by radio technology such as global system for mobile communications (GSM), general packet radio service (GPRS), enhanced data rates for GSM evolution (EDGE) (i.e., GERAN), etc. OFDMA may be implemented by radio technology such as institute of electrical and electronics engineers (IEEE) 802.11 (Wi-Fi), IEEE 802.16 (WiMAX), IEEE 802.20, evolved-UTRA (E-UTRA), etc. UTRA is part of universal mobile telecommunications system (UMTS) and 3rd generation partnership project (3GPP) long-term evolution (LTE) is part of E-UMTS using E-UTRA. 3GPP LTE adopts OFDMA on downlink (DL) and adopts SC-FDMA on uplink (UL). LTE-advanced (LTE-A) is an evolved version of 3GPP LTE.

For convenience of description, description will be given under the assumption that the present disclosure is applied to LTE and/or new RAT (NR). However, the technical features of the present disclosure are not limited thereto. For example, although the following detailed description is given based on mobile communication systems corresponding to 3GPP LTE/NR systems, the mobile communication systems are applicable to other arbitrary mobile communication systems except for matters that are specific to the 3GPP LTE/NR system.

For terms and techniques that are not described in detail among terms and techniques used in the present disclosure, reference may be made to 3GPP based standard specifications, for example, 3GPP TS 36.211, 3GPP TS 36.212, 3GPP TS 36.213, 3GPP TS 36.321, 3GPP TS 36.300, 3GPP TS 36.331, 3GPP TS 37.213, 3GPP TS 38.211, 3GPP TS 38.212, 3GPP TS 38.213, 3GPP TS 38.214, 3GPP TS 38.300, 3GPP TS 38.321, 3GPP TS 38.331, etc.

In examples of the present disclosure described later, if a device “assumes” something, this may mean that a channel transmission entity transmits a channel in compliance with the corresponding “assumption”. This also may mean that a channel reception entity receives or decodes the channel in the form of conforming to the “assumption” on the premise that the channel has been transmitted in compliance with the “assumption”.

In the present disclosure, a user equipment (UE) may be fixed or mobile. Each of various devices that transmit and/or receive user data and/or control information by communicating with a base station (BS) may be the UE. The term UE may be referred to as terminal equipment, mobile station (MS), mobile terminal (MT), user terminal (UT), subscriber station (SS), wireless device, personal digital assistant (PDA), wireless modem, handheld device, etc. In the present disclosure, a BS refers to a fixed station that communicates with a UE and/or another BS and exchanges data and control information with a UE and another BS. The term BS may be referred to as advanced base station (ABS), Node-B (NB), evolved Node-B (eNB), base transceiver system (BTS), access point (AP), processing server (PS), etc. Particularly, a BS of a universal terrestrial radio access (UTRAN) is referred to as an NB, a BS of an evolved-UTRAN (E-UTRAN) is referred to as an eNB, and a BS of new radio access technology network is referred to as a gNB. Hereinbelow, for convenience of description, the NB, eNB, or gNB will be referred to as a BS regardless of the type or version of communication technology.

In the present disclosure, a node refers to a fixed point capable of transmitting/receiving a radio signal to/from a UE by communication with the UE. Various types of BSs may be used as nodes regardless of the names thereof. For example, a BS, NB, eNB, pico-cell eNB (PeNB), home eNB (HeNB), relay, repeater, etc. may be a node. Furthermore, a node may not be a BS. For example, a radio remote head (RRH) or a radio remote unit (RRU) may be a node. Generally, the RRH and RRU have power levels lower than that of the BS. Since the RRH or RRU (hereinafter, RRH/RRU) is connected to the BS through a dedicated line such as an optical cable in general, cooperative communication according to the RRH/RRU and the BS may be smoothly performed relative to cooperative communication according to BSs connected through a wireless link. At least one antenna is installed per node. An antenna may refer to a physical antenna port or refer to a virtual antenna or an antenna group. The node may also be called a point.

In the present disclosure, a cell refers to a specific geographical area in which one or more nodes provide communication services. Accordingly, in the present disclosure, communication with a specific cell may mean communication with a BS or a node providing communication services to the specific cell. A DL/UL signal of the specific cell refers to a DL/UL signal from/to the BS or the node providing communication services to the specific cell. A cell providing UL/DL communication services to a UE is especially called a serving cell. Furthermore, channel status/quality of the specific cell refers to channel status/quality of a channel or a communication link generated between the BS or the node providing communication services to the specific cell and the UE. In 3GPP-based communication systems, the UE may measure a DL channel state from a specific node using cell-specific reference signal(s) (CRS(s)) transmitted on a CRS resource and/or channel state information reference signal(s) (CSI-RS(s)) transmitted on a CSI-RS resource, allocated to the specific node by antenna port(s) of the specific node.

A 3GPP-based communication system uses the concept of a cell in order to manage radio resources, and a cell related with the radio resources is distinguished from a cell of a geographic area.

The “cell” of the geographic area may be understood as coverage within which a node may provide services using a carrier, and the “cell” of the radio resources is associated with bandwidth (BW), which is a frequency range configured by the carrier. Since DL coverage, which is a range within which the node is capable of transmitting a valid signal, and UL coverage, which is a range within which the node is capable of receiving the valid signal from the UE, depend upon a carrier carrying the signal, coverage of the node may also be associated with coverage of the “cell” of radio resources used by the node. Accordingly, the term “cell” may be used to indicate service coverage by the node sometimes, radio resources at other times, or a range that a signal using the radio resources may reach with valid strength at other times.

In 3GPP communication standards, the concept of the cell is used in order to manage radio resources. The “cell” associated with the radio resources is defined by a combination of DL resources and UL resources, that is, a combination of a DL component carrier (CC) and a UL CC. The cell may be configured by the DL resources only or by the combination of the DL resources and the UL resources. If carrier aggregation is supported, linkage between a carrier frequency of the DL resources (or DL CC) and a carrier frequency of the UL resources (or UL CC) may be indicated by system information. For example, the combination of the DL resources and the UL resources may be indicated by system information block type 2 (SIB2) linkage. In this case, the carrier frequency may be equal to or different from a center frequency of each cell or CC. When carrier aggregation (CA) is configured, the UE has only one radio resource control (RRC) connection with a network. During RRC connection establishment/re-establishment/handover, one serving cell provides non-access stratum (NAS) mobility information. During RRC connection re-establishment/handover, one serving cell provides security input. This cell is referred to as a primary cell (Pcell). The Pcell refers to a cell operating on a primary frequency on which the UE performs an initial connection establishment procedure or initiates a connection re-establishment procedure. According to UE capability, secondary cells (Scells) may be configured to form a set of serving cells together with the Pcell. The Scell may be configured after completion of RRC connection establishment and used to provide additional radio resources in addition to resources of a specific cell (SpCell). A carrier corresponding to the Pcell on DL is referred to as a downlink primary CC (DL PCC), and a carrier corresponding to the Pcell on UL is referred to as an uplink primary CC (UL PCC). A carrier corresponding to the Scell on DL is referred to as a downlink secondary CC (DL SCC), and a carrier corresponding to the Scell on UL is referred to as an uplink secondary CC (UL SCC).

In a dual connectivity (DC) operation, the term special cell (SpCell) refers to a Pcell of a master cell group (MCG) or a primary secondary cell (PSCell) of a secondary cell group (SCG). The SpCell supports PUCCH transmission and contention-based random access and is always activated. The MCG is a group of service cells associated with a master node (e.g., BS) and includes the SpCell (Pcell) and optionally one or more Scells. For a UE configured with DC, the SCG is a subset of serving cells associated with a secondary node and includes the PSCell and 0 or more Scells. The PSCell is a primary Scell of the SCG. For a UE in RRC_CONNECTED state, which is not configured with CA or DC, only one serving cell including only the Pcell is present. For a UE in RRC_CONNECTED state, which is configured with CA or DC, the term serving cells refers to a set of cells including SpCell(s) and all Scell(s). In DC, two medium access control (MAC) entities, i.e., one MAC entity for the MCG and one MAC entity for the SCG, are configured for the UE.

For a UE that is configured with CA and is not configured with DC, a Pcell PUCCH group (also called a primary PUCCH group) including the Pcell and 0 or more Scells and an Scell PUCCH group (also called a secondary PUCCH group) including only Scell(s) may be configured. For the Scell, an Scell on which a PUCCH associated with the corresponding cell is transmitted (hereinafter, a PUCCH cell) may be configured. An Scell for which a PUCCH Scell is indicated belongs to the Scell PUCCH group (i.e., the secondary PUCCH group) and PUCCH transmission of related uplink control information (UCI) is performed on the PUCCH Scell. If a PUCCH Scell is not indicated for an Scell or a cell which is indicated for PUCCH transmission for the Scell is a Pcell, the Scell belongs to the Pcell PUCCH group (i.e., the primary PUCCH group) and PUCCH transmission of related UCI is performed on the Pcell. Hereinbelow, if the UE is configured with the SCG and some implementations of the present disclosure related to a PUCCH are applied to the SCG, the primary cell may refer to the PSCell of the SCG. If the UE is configured with the PUCCH Scell and some implementations of the present disclosure related to the PUCCH are applied to the secondary PUCCH group, the primary cell may refer to the PUCCH Scell of the secondary PUCCH group.

In a wireless communication system, the UE receives information on DL from the BS and the UE transmits information on UL to the BS. The information that the BS and UE transmit and/or receive includes data and a variety of control information and there are various physical channels according to types/usage of the information that the UE and the BS transmit and/or receive.

The 3GPP-based communication standards define DL physical channels corresponding to resource elements carrying information originating from a higher layer and DL physical signals corresponding to resource elements which are used by the physical layer but do not carry the information originating from the higher layer. For example, a physical downlink shared channel (PDSCH), a physical broadcast channel (PBCH), a physical multicast channel (PMCH), a physical control format indicator channel (PCFICH), a physical downlink control channel (PDCCH), etc. are defined as the DL physical channels, and a reference signal (RS) and a synchronization signal (SS) are defined as the DL physical signals. The RS, which is also referred to as a pilot, represents a signal with a predefined special waveform known to both the BS and the UE. For example, a demodulation reference signal (DMRS), a channel state information RS (CSI-RS), etc. are defined as DL RSs. The 3GPP-based communication standards define UL physical channels corresponding to resource elements carrying information originating from the higher layer and UL physical signals corresponding to resource elements which are used by the physical layer but do not carry the information originating from the higher layer. For example, a physical uplink shared channel (PUSCH), a physical uplink control channel (PUCCH), and a physical random access channel (PRACH) are defined as the UL physical channels, and a DMRS for a UL control/data signal, a sounding reference signal (SRS) used for UL channel measurement, etc. are defined.

In the present disclosure, a PDCCH refers to a set of time-frequency resources (e.g., resource elements (REs)) carrying downlink control information (DCI), and a PDSCH refers to a set of time-frequency resources carrying DL data. A PUCCH, a PUSCH, and a PRACH refer to a set of time-frequency resources carrying UCI, a set of time-frequency resources carrying UL data, and a set of time-frequency resources carrying random access signals, respectively. In the following description, “the UE transmits/receives a PUCCH/PUSCH/PRACH” is used as the same meaning that the UE transmits/receives the UCI/UL data/random access signals on or through the PUCCH/PUSCH/PRACH, respectively. In addition, “the BS transmits/receives a PBCH/PDCCH/PDSCH” is used as the same meaning that the BS transmits the broadcast information/DCI/DL data on or through a PBCH/PDCCH/PDSCH, respectively.

In this specification, a radio resource (e.g., a time-frequency resource) scheduled or configured to the UE by the BS for transmission or reception of the PUCCH/PUSCH/PDSCH may be referred to as a PUCCH/PUSCH/PDSCH resource.

Since a communication device receives a synchronization signal block (SSB), DMRS, CSI-RS, PBCH, PDCCH, PDSCH, PUSCH, and/or PUCCH in the form of radio signals on a cell, the communication device may not select and receive radio signals including only a specific physical channel or a specific physical signal through a radio frequency (RF) receiver, or may not select and receive radio signals without a specific physical channel or a specific physical signal through the RF receiver. In actual operations, the communication device receives radio signals on the cell via the RF receiver, converts the radio signals, which are RF band signals, into baseband signals, and then decodes physical signals and/or physical channels in the baseband signals using one or more processors. Thus, in some implementations of the present disclosure, not receiving physical signals and/or physical channels may mean that a communication device does not attempt to restore the physical signals and/or physical channels from radio signals, for example, does not attempt to decode the physical signals and/or physical channels, rather than that the communication device does not actually receive the radio signals including the corresponding physical signals and/or physical channels.

As more and more communication devices have required greater communication capacity, there has been a need for eMBB communication relative to legacy radio access technology (RAT). In addition, massive MTC for providing various services at anytime and anywhere by connecting a plurality of devices and objects to each other is one main issue to be considered in next-generation communication. Further, communication system design considering services/UEs sensitive to reliability and latency is also under discussion. The introduction of next-generation RAT is being discussed in consideration of eMBB communication, massive MTC, ultra-reliable and low-latency communication (URLLC), and the like. Currently, in 3GPP, a study on the next-generation mobile communication systems after EPC is being conducted. In the present disclosure, for convenience, the corresponding technology is referred to as a new RAT (NR) or fifth-generation (5G) RAT, and a system using NR or supporting NR is referred to as an NR system.

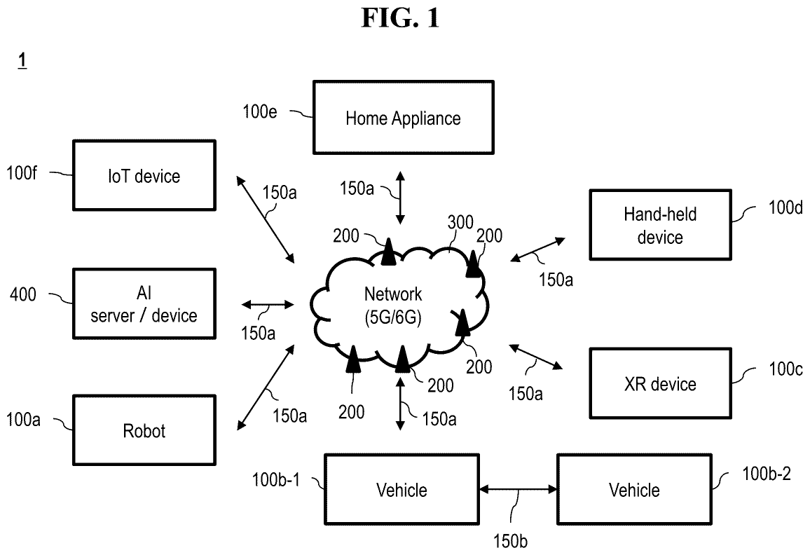

FIG. 1 illustrates an example of a communication system 1 to which implementations of the present disclosure are applied. Referring to FIG. 1, the communication system 1 applied to the present disclosure includes wireless devices, BSs, and a network. Here, the wireless devices represent devices performing communication using RAT (e.g., 5G NR or LTE (e.g., E-UTRA)) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Here, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or smartglasses), and a computer (e.g., a notebook). The home appliance may include a TV, a refrigerator, and a washing machine. The IoT device may include a sensor and a smartmeter. For example, the BSs and the network may also be implemented as wireless devices and a specific wireless device may operate as a BS/network node with respect to another wireless device.

The wireless devices 100a to 100f may be connected to a network 300 via BSs 200. AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., vehicle-to-vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f and the BSs 200 and between the wireless devices 100a to 100f). Here, the wireless communication/connections such as UL/DL communication 150a and sidelink communication 150b (or, device-to-device (D2D) communication) may be established by various RATs (e.g., 5G NR). The wireless devices and the BSs/wireless devices may transmit/receive radio signals to/from each other through the wireless communication/connections 150a and 150b. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

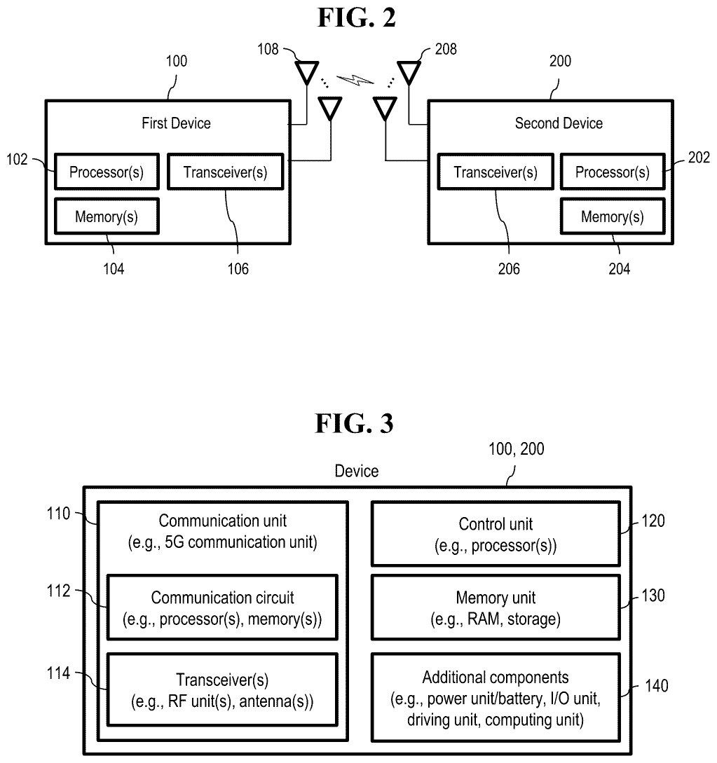

FIG. 2 is a block diagram illustrating examples of communication devices capable of performing a method according to the present disclosure. Referring to FIG. 2, a first wireless device 100 and a second wireless device 200 may transmit and/or receive radio signals through a variety of RATs (e.g., LTE and NR). Here, {the first wireless device 100 and the second wireless device 200} may correspond to {the wireless device 100x and the BS 200} and/or {the wireless device 100x and the wireless device 100x} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the below-described/proposed functions, procedures, and/or methods. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may perform a part or all of processes controlled by the processor(s) 102 or store software code including instructions for performing the below-described/proposed procedures and/or methods. Here, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 is used interchangeably with radio frequency (RF) unit(s). In the present disclosure, the wireless device may represent the communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the below-described/proposed functions, procedures, and/or methods. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may perform a part or all of processes controlled by the processor(s) 202 or store software code including instructions for performing the below-described/proposed procedures and/or methods. Here, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 is used interchangeably with RF unit(s). In the present disclosure, the wireless device may represent the communication modem/circuit/chip.

The wireless communication technology implemented in the wireless devices 100 and 200 of the present disclosure may include narrowband Internet of things for low-power communication as well as LTE, NR, and 6G. For example, the NB-IoT technology may be an example of low-power wide-area network (LPWAN) technologies and implemented in standards such as LTE Cat NB1 and/or LTE Cat NB2. However, the NB-IoT technology is not limited to the above names. Additionally or alternatively, the wireless communication technology implemented in the wireless devices XXX and YYY of the present disclosure may perform communication based on the LTE-M technology. For example, the LTE-M technology may be an example of LPWAN technologies and called by various names including enhanced machine type communication (eMTC). For example, the LTE-M technology may be implemented in at least one of the following various standards: 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, etc., but the LTE-M technology is not limited to the above names. Additionally or alternatively, the wireless communication technology implemented in the wireless devices XXX and YYY of the present disclosure may include at least one of ZigBee, Bluetooth, and LPWAN in consideration of low-power communication, but the wireless communication technology is not limited to the above names. For example, the ZigBee technology may create a personal area network (PAN) related to small/low-power digital communication based on various standards such as IEEE 802.15.4 and so on, and the ZigBee technology may be called by various names.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as a physical (PHY) layer, medium access control (MAC) layer, a radio link control (RLC) layer, a packet data convergence protocol (PDCP) layer, radio resource control (RRC) layer, and a service data adaptation protocol (SDAP) layer). The one or more processors 102 and 202 may generate one or more protocol data units (PDUs) and/or one or more service data units (SDUs) according to the functions, procedures, proposals, and/or methods disclosed in the present disclosure. The one or more processors 102 and 202 may generate messages, control information, data, or information according to the functions, procedures, proposals, and/or methods disclosed in the present disclosure. The one or more processors 102 and 202 may generate signals (e.g., baseband signals) including PDUs, SDUs, messages, control information, data, or information according to the functions, procedures, proposals, and/or methods disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The functions, procedures, proposals, and/or methods disclosed in the present disclosure may be implemented using firmware or software, and the firmware or software may be configured to include the modules, procedures, or functions. Firmware or software configured to perform the functions, procedures, proposals, and/or methods disclosed in the present disclosure may be included in the one or more processors 102 and 202 or stored in the one or more memories 104 and 204 so as to be driven by the one or more processors 102 and 202. The functions, procedures, proposals, and/or methods disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, commands, and/or instructions. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of the present disclosure, to one or more other devices. The one or more transceivers 106 and 206 may receive user data, control information, and/or radio signals/channels, mentioned in the functions, procedures, proposals, methods, and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208. The one or more transceivers 106 and 206 may be configured to transmit and receive user data, control information, and/or radio signals/channels, mentioned in the functions, procedures, proposals, methods, and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 3 illustrates another example of a wireless device capable of performing implementation(s) of the present disclosure. Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 2. For example, the transceiver(s) 114 may include the one or more transceivers 106 and 206 and/or the one or more antennas 108 and 208 of FIG. 2. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast UE, a hologram device, a public safety device, an MTC device, a medicine device, a fintech device (or a finance device), a security device, a climate/environment device, the AI server/device (400 of FIG. 1), the BS (200 of FIG. 1), a network node, etc. The wireless device may be used in a mobile or fixed place according to a use-case/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a random access memory (RAM), a dynamic RAM (DRAM), a read-only memory (ROM)), a flash memory, a transitory memory, a non-transitory memory, and/or a combination thereof.

In the present disclosure, the at least one memory (e.g., 104 or 204) may store instructions or programs, and the instructions or programs may cause, when executed, at least one processor operably connected to the at least one memory to perform operations according to some embodiments or implementations of the present disclosure.

In the present disclosure, a computer readable (non-transitory) storage medium may store at least one instruction or program, and the at least one instruction or program may cause, when executed by at least one processor, the at least one processor to perform operations according to some embodiments or implementations of the present disclosure.

In the present disclosure, a processing device or apparatus may include at least one processor, and at least one computer memory operably connected to the at least one processor. The at least one computer memory may store instructions or programs, and the instructions or programs may cause, when executed, the at least one processor operably connected to the at least one memory to perform operations according to some embodiments or implementations of the present disclosure.

In the present disclosure, a computer program may include program code stored on at least one computer-readable (non-transitory) storage medium and, when executed, configured to perform operations according to some implementations of the present disclosure or cause at least one processor to perform the operations according to some implementations of the present disclosure. The computer program may be provided in the form of a computer program product. The computer program product may include at least one computer-readable (non-transitory) storage medium.

A communication device of the present disclosure includes at least one processor; and at least one computer memory operably connected to the at least one processor and configured to store instructions for causing, when executed, the at least one processor to perform operations according to example(s) of the present disclosure described later.

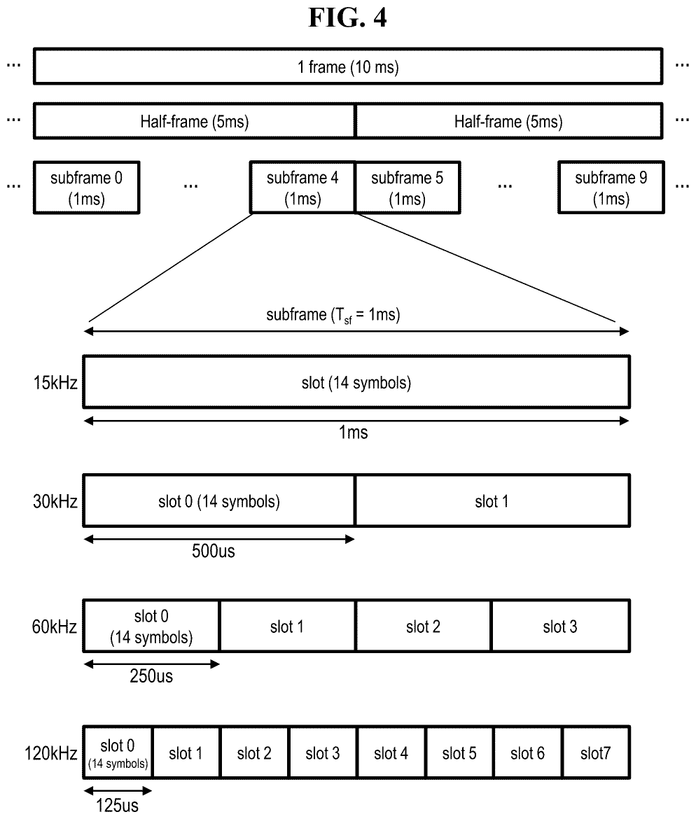

FIG. 4 illustrates an example of a frame structure used in a 3GPP-based wireless communication system.

The frame structure of FIG. 4 is purely exemplary and the number of subframes, the number of slots, and the number of symbols, in a frame, may be variously changed. In an NR system, different OFDM numerologies (e.g., subcarrier spacings (SCSs)) may be configured for multiple cells which are aggregated for one UE. Accordingly, the (absolute time) duration of a time resource including the same number of symbols (e.g., a subframe, a slot, or a transmission time interval (TTI)) may be differently configured for the aggregated cells. Here, the symbol may include an OFDM symbol (or cyclic prefix—OFDM (CP-OFDM) symbol) and an SC-FDMA symbol (or discrete Fourier transform-spread-OFDM (DFT-s-OFDM) symbol). In the present disclosure, the symbol, the OFDM-based symbol, the OFDM symbol, the CP-OFDM symbol, and the DFT-s-OFDM symbol are used interchangeably.

Referring to FIG. 4, in the NR system, UL and DL transmissions are organized into frames. Each frame has a duration of T_{f}=(Δfₘₐₓ*N_{f}/100)*T_{c}=10 ms and is divided into two half-frames of 5 ms each. A basic time unit for NR is T_{c}=1/(Δfₘₐₓ*N_{f}) where Δfₘₐₓ=480*10³ Hz and N_{f}=4096. For reference, a basic time unit for LTE is Tₛ=1/(Δf_{ref}*N_{f,ref}) where Δf_{ref}=15*10³ Hz and N_{f,ref}=2048. T_{c} and T_{f} have the relationship of a constant κ=T_{c}/T_{f}=64. Each half-frame includes 5 subframes and a duration T_{sf} of a single subframe is 1 ms. Subframes are further divided into slots and the number of slots in a subframe depends on a subcarrier spacing. Each slot includes 14 or 12 OFDM symbols based on a cyclic prefix. In a normal CP, each slot includes 14 OFDM symbols and, in an extended CP, each slot includes 12 OFDM symbols. The numerology depends on an exponentially scalable subcarrier spacing Δf=2^{u}*15 kHz. The table below shows the number of OFDM symbols (N^{slot}_{symb}) per slot, the number of slots (N^{frame,u}ₛₗₒₜ) per frame, and the number of slots (N^{subframe,u}ₛₗₒₜ) per subframe.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The table below shows the number of OFDM symbols per slot, the number of slots per frame, and the number of slots per subframe, according to the subcarrier spacing Δf=2u*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

For a subcarrier spacing configuration u, slots may be indexed within a subframe in ascending order as follows: n^{u}ₛ∈{0, . . . , n^{subframe,u}ₛₗₒₜ−1} and indexed within a frame in ascending order as follows: n^{u}_{s,f}∈{0, . . . , n^{frame,u}ₛₗₒₜ−1}.

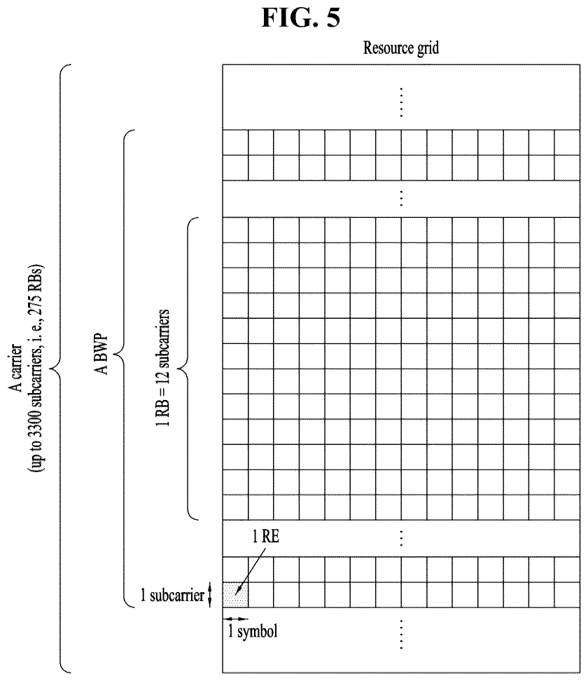

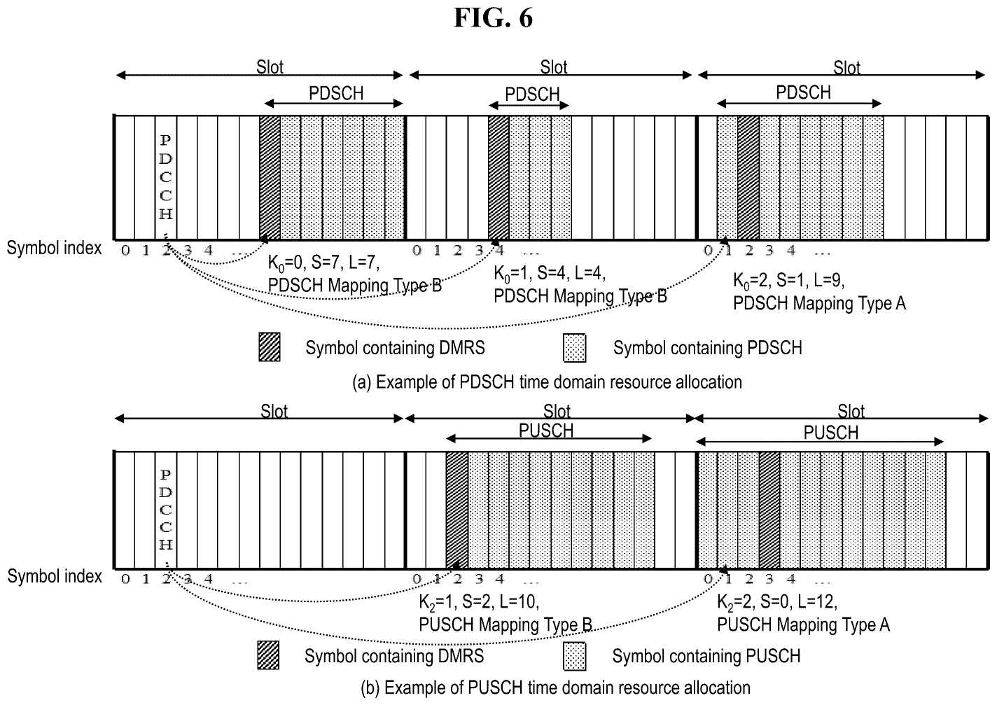

FIG. 5 illustrates a resource grid of a slot. The slot includes multiple (e.g., 14 or 12) symbols in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at a common resource block (CRB) N^{start,u}_{grid} indicated by higher layer signaling (e.g. RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP-based wireless communication system, N^{RB}_{sc} is typically 12. There is one resource grid for a given antenna port p, a subcarrier spacing configuration u, and a transmission link (DL or UL). The carrier bandwidth N^{size,u}_{grid} for the subcarrier spacing configuration u is given to the UE by a higher layer parameter (e.g. RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the NR system, an RB is defined by 12 consecutive subcarriers in the frequency domain. In the NR system, RBs are classified into CRBs and physical resource blocks (PRBs). The CRBs are numbered from 0 upwards in the frequency domain for the subcarrier spacing configuration u. The center of subcarrier 0 of CRB 0 for the subcarrier spacing configuration u is equal to ‘Point A’ which serves as a common reference point for RB grids. The PRBs for subcarrier spacing configuration u are defined within a bandwidth part (BWP) and numbered from 0 to N^{size,u}_{BWP,i}−1, where i is a number of the BWP. The relation between a PRB n_{PRB} in a BWP i and a CRB n^{u}_{CRB} is given by: n^{u}_{PRB}=n^{u}_{CRB}+N^{size,u}_{BWP,i} where N^{size}_{BWP,i} is a CRB in which the BWP starts relative to CRB 0. The BWP includes a plurality of consecutive RBs in the frequency domain. For example, the BWP may be a subset of contiguous CRBs defined for a given numerology uᵢ in the BWP i on a given carrier. A carrier may include a maximum of N (e.g., 5) BWPs. The UE may be configured to have one or more BWPs on a given component carrier. Data communication is performed through an activated BWP and only a predetermined number of BWPs (e.g., one BWP) among BWPs configured for the UE may be active on the component carrier.

For each serving cell in a set of DL BWPs or UL BWPs, the network may configure at least an initial DL BWP and one (if the serving cell is configured with uplink) or two (if supplementary uplink is used) initial UL BWPs. The network may configure additional UL and DL BWPs. For each DL BWP or UL BWP, the UE may be provided the following parameters for the serving cell: i) an SCS; ii) a CP; iii) a CRB N^{start}_{BWP}=O_{carrier}+RBₛₜₐᵣₜ and the number of contiguous RBs N^{size}_{BWP}=L_{RB} provided by an RRC parameter locationAndBandwidth, which indicates an offset RBₛₑₜ and a length L_{RB} as a resource indicator value (RIV) on the assumption of N^{start}_{BWP}=275, and a value O_{carrier} provided by an RRC parameter offsetToCarrier for the SCS; an index in the set of DL BWPs or UL BWPs; a set of BWP-common parameters; and a set of BWP-dedicated parameters.

Virtual resource blocks (VRBs) may be defined within the BWP and indexed from 0 to N^{size,u}_{BWP,i}−1, where i denotes a BWP number. The VRBs may be mapped to PRBs according to interleaved mapping or non-interleaved mapping. In some implementations, VRB n may be mapped to PRB n for non-interleaved VRB-to-PRB mapping.

The UE for which carrier aggregation is configured may be configured to use one or more cells. If the UE is configured with a plurality of serving cells, the UE may be configured with one or multiple cell groups. The UE may also be configured with a plurality of cell groups associated with different BSs. Alternatively, the UE may be configured with a plurality of cell groups associated with a single BS. Each cell group of the UE includes one or more serving cells and includes a single PUCCH cell for which PUCCH resources are configured. The PUCCH cell may be a Pcell or an Scell configured as the PUCCH cell among Scells of a corresponding cell group. Each serving cell of the UE belongs to one of cell groups of the UE and does not belong to a plurality of cells.

NR frequency bands are defined as two types of frequency ranges, i.e., FR1 and FR2. FR2 is also referred to as millimeter wave (mmW). The following table shows frequency ranges within which NR may operate.

TABLE 3

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

Hereinafter, physical channels that may be used in the 3GPP-based wireless communication system will be described in detail.

A PDCCH carries DCI. For example, the PDCCH (i.e., DCI) carries information about transport format and resource allocation of a downlink shared channel (DL-SCH), information about resource allocation of an uplink shared channel (UL-SCH), paging information about a paging channel (PCH), system information about the DL-SCH, information about resource allocation for a control message, such as a random access response (RAR) transmitted on a PDSCH, of a layer (hereinafter, higher layer) positioned higher than a physical layer among protocol stacks of the UE/BS, a transmit power control command, information about activation/deactivation of configured scheduling (CS), etc. DCI including resource allocation information on the DL-SCH is called PDSCH scheduling DCI, and DCI including resource allocation information on the UL-SCH is called PUSCH scheduling DCI. The DCI includes a cyclic redundancy check (CRC). The CRC is masked/scrambled with various identifiers (e.g., radio network temporary identifier (RNTI)) according to an owner or usage of the PDCCH. For example, if the PDCCH is for a specific UE, the CRS is masked with a UE identifier (e.g., cell-RNTI (C-RNTI)). If the PDCCH is for a paging message, the CRC is masked with a paging RNTI (P-RNTI). If the PDCCH is for system information (e.g., system information block (SIB)), the CRC is masked with a system information RNTI (SI-RNTI). If the PDCCH is for a random access response, the CRC is masked with a random access-RNTI (RA-RNTI).

When a PDCCH on one serving cell schedules a PDSCH or a PUSCH on another serving cell, it is referred to cross-carrier scheduling. Cross-carrier scheduling with a carrier indicator field (CIF) may allow a PDCCH on a serving cell to schedule resources on another serving cell. When a PDSCH on a serving cell schedules a PDSCH or a PUSCH on the serving cell, it is referred to as self-carrier scheduling. When the cross-carrier scheduling is used in a cell, the BS may provide information about a cell scheduling the cell to the UE. For example, the BS may inform the UE whether a serving cell is scheduled by a PDCCH on another (scheduling) cell or scheduled by the serving cell. If the serving cell is scheduled by the other (scheduling) cell, the BS may inform the UE which cell signals DL assignments and UL grants for the serving cell. In the present disclosure, a cell carrying a PDCCH is referred to as a scheduling cell, and a cell where transmission of a PUSCH or a PDSCH is scheduled by DCI included in the PDCCH, that is, a cell carrying the PUSCH or PDSCH scheduled by the PDCCH is referred to as a scheduled cell.

A PDSCH is a physical layer UL channel for UL data transport. The PDSCH carries DL data (e.g., DL-SCH transport block) and is subjected to modulation such as quadrature phase shift keying (QPSK), 16 quadrature amplitude modulation (QAM), 64 QAM, 256 QAM, etc. A codeword is generated by encoding a transport block (TB). The PDSCH may carry a maximum of two codewords. Scrambling and modulation mapping per codeword may be performed and modulation symbols generated from each codeword may be mapped to one or more layers. Each layer is mapped to a radio resource together with a DMRS and generated as an OFDM symbol signal. Then, the OFDM symbol signal is transmitted through a corresponding antenna port.

A PUCCH is a physical layer UL channel for uplink control information (UCI) transmission. The PUCCH carries UCI. UCI types transmitted on the PUCCH include hybrid automatic repeat request acknowledgement (HARQ-ACK) information, a scheduling request (SR), and channel state information (CSI). UCI bits include HARQ-ACK information bits if present, SR information bits if present, link recovery request (LRR) information bits if present, and CSI bits if present. In the present disclosure, HARQ-ACK information bits correspond to a HARQ-ACK codebook. In particular, a bit sequence in which HARQ-ACK information bits are arranged according to a predetermined rule is called a HARQ-ACK codebook.
Scheduling request (SR): Information that is used to request a UL-SCH resource.
Hybrid automatic repeat request (HARQ)—acknowledgment (ACK): A response to a DL data packet (e.g., codeword) on the PDSCH. HARQ-ACK indicates whether the DL data packet has been successfully received by a communication device. In response to a single codeword, 1-bit HARQ-ACK may be transmitted. In response to two codewords, 2-bit HARQ-ACK may be transmitted. The HARQ-ACK response includes positive ACK (simply, ACK), negative ACK (NACK), discontinuous transmission (DTX), or NACK/DTX. Here, the term HARQ-ACK is used interchangeably with HARQ ACK/NACK, ACK/NACK, or A/N.
Channel state information (CSI): Feedback information about a DL channel. The CSI may include channel quality information (CQI), a rank indicator (RI), a precoding matrix indicator (PMI), a CSI-RS resource indicator (CRI), an SS/PBCH resource block indicator (SSBRI), and a layer indicator (L1). The CSI may be classified into CSI part 1 and CSI part 2 according to UCI type included in the CSI. For example, the CRI, RI, and/or the CQI for the first codeword may be included in CSI part 1, and LI, PMI, and/or the CQI for the second codeword may be included in CSI part 2.

### —Link Recovery Request (LRR)

In the present disclosure, for convenience, PUCCH resources configured/indicated for/to the UE by the BS for HARQ-ACK, SR, and CSI transmission are referred to as a HARQ-ACK PUCCH resource, an SR PUCCH resource, and a CSI PUCCH resource, respectively.

A scheduling request (SR) is used for the UE to request UL-SCH resources for a (new) transmission. A MAC entity in the MAC layer above the PHY layer may be configured with zero, one, or more SR configurations. An SR configuration includes a set of PUCCH resources for an SR across different BWPs. To accommodate different types of data transfer services, a plurality of types of logical channels are defined, each supporting a specific type of information. The MAC entity supports mapping between logical channels and transport channels (e.g., UL-SCH and DL SCH). For a logical channel, at most one PUCCH resource for an SR is configured per BWP. For a logical channel, for example, an SR configuration applicable to the logical channel may be indicated to the UE by the ID of the SR configuration. Each SR configuration corresponds to one or more logical channels. Each logical channel may be mapped to zero or more SR configurations, which are configured by RRC signaling from the network. If an SR is triggered, the MAC entity has an SR transmission occasion on a valid PUCCH resource configured for the SR, an SR prohibit timer is not running at the time of the SR transmission occasion, and the PUCCH resource for the SR transmission occasion does not overlap with a measurement gap or with a UL-SCH resource (e.g., a PUSCH resource), the MAC entity instructs the PHY layer below the MAC layer to signal the SR on one valid PUCCH resource for the SR. If, for a logical channel belonging to a logical channel group including the one or more logical channels, UL data is available to the MAC entity and if there is no UL resource available for a new transmission, the SR may be triggered.

The UE is configured, by a higher-layer (e.g., RRC) parameter SchedulingRequestResourceConfig provided by the network, with a set of configurations for an SR in a PUCCH transmission using either PUCCH format 0 or PUCCH format 1. The higher-layer (e.g., RRC) parameter SchedulingRequestResourceConfig may include a parameter SchedulingRequestResourceId identifying an SR resource on a PUCCH, a parameter SchedulingRequestId indicating the ID of an SR configuration using the SR resource, and a parameter periodicityAndOffse indicating an SR periodicity and an SR offset. The parameter SchedulingRequestResourceConfig may include the ID of a PUCCH resource on which the UE will transmit the SR. The UE is configured with the PUCCH resource by the higher-layer parameter SchedulingRequestResourceId providing a PUCCH format 0 resource or a PUCCH format 1 resource. The UE is also configured with a periodicity SR_{PERIODICITY} in symbols or slots and an offset SR_{OFFSET} in slots by the higher-layer parameter periodicityAndOffset of the network for a PUCCH transmission conveying the SR. If SR_{PERIODICITY} is larger than one slot, the UE may determine the SR transmission occasion in the PUCCH to be in a slot with number N^{u}_{s,f} in a frame with number n_{f} if (n_{f}*N^{frame,u}ₛₗₒₜ+n^{u}_{s,f}−SR_{OFFSET})modSR_{PERIODICITY}=0. If SR_{PERIODICITY} is one slot, the UE expects that SR_{OFFSET}=0 and every slot is an SR transmission occasion in the PUCCH. If SR_{PERIODICITY} is smaller than one slot, the UE determines the SR transmission occasion in the PUCCH to start in a symbol with index l if (l−l₀modSR_{PERIODICITY})modSR_{PERIODICITY}=0 where l₀ is the index of the starting symbol of the corresponding PUCCH format. According to some scenarios (e.g., 3GPP TS 38.213 Rel-15), the UE transmits a PUCCH in a PUCCH resource for a corresponding SR configuration only when the UE transmits a positive SR. Further, according to some scenarios (e.g., 3GPP TS 38.213 Rel-150), the UE is configured to transmit K PUCCHs for respective K SRs in a slot, as determined by a set of SchedulingRequestResourceId, with SR transmission occasions that would overlap with a PUCCH transmission with HARQ-ACK information from the UE in the slot or with a PUCCH transmission with CSI report(s) from the UE in the slot.

For example, if the UE would transmit a PUCCH with O_{ACK} HARQ-ACK information bits in a resource using PUCCH format 2 or PUCCH format 3 or PUCCH format 4 in a slot, ceil{log₂(K+1)} bits representing a negative or positive SR are appended to the HARQ-ACK information bits in ascending order of the values of SchedulingRequestResourceId, and the UE transmits the combined UCI bits on a PUCCH using a resource with PUCCH format 2 or PUCCH format 3 or PUCCH format 4 for transmission of HARQ-ACK information bits. An all-zero value for the ceil{log₂(K+1)} bits represents a negative SR value across all K SRs.

In another example, if the UE would transmit periodic/semi-persistent CSI in a resource using PUCCH format 2 or PUCCH format 3 or PUCCH format 4 in a slot, ceil{log₂(K+1)} bits representing the corresponding negative or positive SR are prepended to the periodic/semi-persistent CSI bits in ascending order of the values of SchedulingRequestResourceId, and the UE transmits a PUCCH with the combined UCI bits in a resource with PUCCH format 2 or PUCCH format 3 or PUCCH format 4 for CSI reporting.

PUCCH formats may be defined as follows according to UCI payload sizes and/or transmission lengths (e.g., the number of symbols included in PUCCH resources). In regard to the PUCCH formats, reference may also be made to Table 4.

### (0) PUCCH Format 0 (PF0 or F0)

Supported UCI payload size: up to K bits (e.g., K=2)
Number of OFDM symbols constituting a single PUCCH: 1 to X symbols (e.g., X=2)
Transmission structure: Only a UCI signal without a DMRS is included in PUCCH format 0. The UE transmits a UCI state by selecting and transmitting one of a plurality of sequences. For example, the UE transmits specific UCI to the BS by transmitting one of a plurality of sequences through a PUCCH, which is PUCCH format 0. The UE transmits the PUCCH, which is PUCCH format 0, in PUCCH resources for a corresponding SR configuration only upon transmitting a positive SR.
Configuration for PUCCH format 0 includes the following parameters for a corresponding PUCCH resource: an index for initial cyclic shift, the number of symbols for PUCCH transmission, and/or the first symbol for PUCCH transmission.

### (1) PUCCH Format 1 (PF1 or F1)

Supported UCI payload size: up to K bits (e.g., K=2)
Number of OFDM symbols constituting a single PUCCH: Y to Z symbols (e.g., Y=4 and Z=14)
Transmission structure: The DMRS and UCI are configured/mapped in TDM in/to different OFDM symbols. In other words, the DMRS is transmitted in symbols in which modulation symbols are not transmitted and the UCI is represented as the product between a specific sequence (e.g., orthogonal cover code (OCC)) and a modulation (e.g., QPSK) symbol. Code division multiplexing (CDM) is supported between a plurality of PUCCH resources (conforming to PUCCH format 1) (within the same RB) by applying cyclic shifts (CSs)/OCCs to both the UCI and the DMRS. PUCCH format 1 carries the UCI of up to 2 bits and the modulation symbols are spread by the OCC (differently configured depending on whether frequency hopping is performed) in the time domain.
Configuration for PUCCH format 1 includes the following parameters for a corresponding PUCCH resource: an index for initial cyclic shift, the number of symbols for PUCCH transmission, the first symbol for PUCCH transmission, and/or an index for the OCC.

### (2) PUCCH Format 2 (PF2 or F2)

Supported UCI payload size: more than K bits (e.g., K=2)
Number of OFDM symbols constituting a single PUCCH: 1 to X symbols (e.g., X=2)
Transmission structure: The DMRS and UCI are configured/mapped using frequency division multiplexing (FDM) within the same symbol. The UE transmits the UCI by applying only IFFT without DFT to encoded UCI bits. PUCCH format 2 carries UCI of a larger bit size than K bits and modulation symbols are subjected to FDM with the DMRS, for transmission. For example, the DMRS is located in symbol indexes #1, #4, #7, and #10 within a given RB with the density of ⅓. A pseudo noise (PN) sequence is used for a DMRS sequence. Frequency hopping may be activated for 2-symbol PUCCH format 2.
Configuration for PUCCH format 2 includes the following parameters for a corresponding PUCCH resource: the number of PRBs, the number of symbols for PUCCH transmission, and/or the first symbol for PUCCH transmission.

### (3) PUCCH Format 3 (PF3 or F3)

Supported UCI payload size: more than K bits (e.g., K=2)
Number of OFDM symbols constituting a single PUCCH: Y to Z symbols (e.g., Y=4 and Z=14)
Transmission structure: The DMRS and UCI are configured/mapped in TDM for/to different OFDM symbols. The UE transmits the UCI by applying DFT to encoded UCI bits. PUCCH format 3 does not support UE multiplexing for the same time-frequency resource (e.g., same PRB).

Configuration for PUCCH format 3 includes the following parameters for a corresponding PUCCH resource: the number of PRBs, the number of symbols for PUCCH transmission, and/or the first symbol for PUCCH transmission.

### (4) PUCCH Format 4 (PF4 or F4)

Supported UCI payload size: more than K bits (e.g., K=2)
Number of OFDM symbols constituting a single PUCCH: Y to Z symbols (e.g., Y=4 and Z=14)
Transmission structure: The DMRS and UCI are configured/mapped in TDM for/to different OFDM symbols. PUCCH format 4 may multiplex up to 4 UEs in the same PRB, by applying an OCC at the front end of DFT and applying a CS (or interleaved FDM (IFDM) mapping) to the DMRS. In other words, modulation symbols of the UCI are subjected to TDM with the DMRS, for transmission.
Configuration for PUCCH format 4 includes the following parameters for a corresponding PUCCH resource: the number of symbols for PUCCH transmission, length for the OCC, an index for the OCC, and the first symbol for PUCCH transmission.

The table below shows the PUCCH formats. The PUCCH formats may be divided into short PUCCH formats (formats 0 and 2) and long PUCCH formats (formats 1, 3, and 4) according to PUCCH transmission length.

TABLE 4

| | Length in | | | |
|---|---|---|---|---|
| | OFDM | | | |
| PUCCH | symbols | Number | | |
| format | N^{PUCCH}_{symb} | of bits | Usage | Etc. |
| 0 | 1-2 | =<2 | HARQ, SR | Sequence selection |
| 1 | 4-14 | =<2 | HARQ, [SR] | Sequence modula- |
| | | | | tion |
| 2 | 1-2 | >2 | HARQ, CSI, [SR] | CP-OFDM |
| 3 | 4-14 | >2 | HARQ, CSI, [SR] | DFT-s-OFDM(no |
| | | | | UE multiplexing) |
| 4 | 4-14 | >2 | HARQ, CSI, [SR] | DFT-s-OFDM(Pre |
| | | | | DFT OCC) |

A PUCCH resource may be determined according to a UCI type (e.g., A/N, SR, or CSI). A PUCCH resource used for UCI transmission may be determined based on a UCI (payload) size. For example, the BS may configure a plurality of PUCCH resource sets for the UE, and the UE may select a specific PUCCH resource set corresponding to a specific range according to the range of the UCI (payload) size (e.g., numbers of UCI bits). For example, the UE may select one of the following PUCCH resource sets according to the number of UCI bits, N_{UCI}.
PUCCH resource set #0, if the number of UCI bits=<2
PUCCH resource set #1, if 2<the number of UCI bits=<N₁
. . .
PUCCH resource set #(K−1), if N_{K-2}<the number of UCI bits=<N_{K-1}

Here, K represents the number of PUCCH resource sets (K>1) and Ni represents a maximum number of UCI bits supported by PUCCH resource set #i. For example, PUCCH resource set #1 may include resources of PUCCH formats 0 to 1, and the other PUCCH resource sets may include resources of PUCCH formats 2 to 4 (see Table 4).

Configuration for each PUCCH resource includes a PUCCH resource index, a start PRB index, and configuration for one of PUCCH format 0 to PUCCH format 4. The UE is configured with a code rate for multiplexing HARQ-ACK, SR, and CSI report(s) within PUCCH transmission using PUCCH format 2, PUCCH format 3, or PUCCH format 4, by the BS through a higher layer parameter maxCodeRate. The higher layer parameter maxCodeRate is used to determine how to feed back the UCI on PUCCH resources for PUCCH format 2, 3, or 4.

If the UCI type is SR and CSI, a PUCCH resource to be used for UCI transmission in a PUCCH resource set may be configured for the UE through higher layer signaling (e.g., RRC signaling). If the UCI type is HARQ-ACK for a semi-persistent scheduling (SPS) PDSCH, the PUCCH resource to be used for UCI transmission in the PUCCH resource set may be configured for the UE through higher layer signaling (e.g., RRC signaling). On the other hand, if the UCI type is HARQ-ACK for a PDSCH scheduled by DCI, the PUCCH resource to be used for UCI transmission in the PUCCH resource set may be scheduled by the DCI.

In the case of DCI-based PUCCH resource scheduling, the BS may transmit the DCI to the UE on a PDCCH and indicate a PUCCH resource to be used for UCI transmission in a specific PUCCH resource set by an ACK/NACK resource indicator (ARI) in the DCI. The ARI may be used to indicate a PUCCH resource for ACK/NACK transmission and also be referred to as a PUCCH resource indicator (PRI). Here, the DCI may be used for PDSCH scheduling and the UCI may include HARQ-ACK for a PDSCH. The BS may configure a PUCCH resource set including a larger number of PUCCH resources than states representable by the ARI by (UE-specific) higher layer (e.g., RRC) signaling for the UE. The ARI may indicate a PUCCH resource subset of the PUCCH resource set and which PUCCH resource in the indicated PUCCH resource subset is to be used may be determined according to an implicit rule based on transmission resource information about the PDCCH (e.g., the starting CCE index of the PDCCH).

For UL-SCH data transmission, the UE should include UL resources available for the UE and, for DL-SCH data reception, the UE should include DL resources available for the UE. The UL resources and the DL resources are assigned to the UE by the BS through resource allocation. Resource allocation may include time domain resource allocation (TDRA) and frequency domain resource allocation (FDRA). In the present disclosure, UL resource allocation is also referred to as a UL grant and DL resource allocation is referred to as DL assignment. The UL grant is dynamically received by the UE on the PDCCH or in RAR or semi-persistently configured for the UE by the BS through RRC signaling. DL assignment is dynamically received by the UE on the PDCCH or semi-persistently configured for the UE by the BS through RRC signaling.

On UL, the BS may dynamically allocate UL resources to the UE through PDCCH(s) addressed to a cell radio network temporary Identifier (C-RNTI). The UE monitors the PDCCH(s) in order to discover possible UL grant(s) for UL transmission. The BS may allocate the UL resources using a configured grant to the UE. Two types of configured grants, Type 1 and Type 2, may be used. In Type 1, the BS directly provides the configured UL grant (including periodicity) through RRC signaling. In Type 2, the BS may configure a periodicity of an RRC-configured UL grant through RRC signaling and signal, activate, or deactivate the configured UL grant through the PDCCH addressed to a configured scheduling RNTI (CS-RNTI). For example, in Type 2, the PDCCH addressed to the CS-RNTI indicates that the corresponding UL grant may be implicitly reused according to the configured periodicity through RRC signaling until deactivation.

On DL, the BS may dynamically allocate DL resources to the UE through PDCCH(s) addressed to the C-RNTI. The UE monitors the PDCCH(s) in order to discover possible DL grant(s). The BS may allocate the DL resources to the UE using SPS. The BS may configure a periodicity of configured DL assignment through RRC signaling and signal, activate, or deactivate the configured DL assignment through the PDCCH addressed to the CS-RNTI. For example, the PDCCH addressed to the CS-RNTI indicates that the corresponding DL assignment may be implicitly reused according to the configured periodicity through RRC signaling until deactivation.

Hereinafter, resource allocation by the PDCCH and resource allocation by RRC will be described in more detail.

### *Resource Allocation by PDCCH: Dynamic Grant/Assignment

The PDCCH may be used to schedule DL transmission on the PDSCH and UL transmission on the PUSCH. DCI on the PDCCH for scheduling DL transmission may include DL resource assignment that at least includes a modulation and coding format (e.g., modulation and coding scheme (MCS)) index I_{MCS}), resource allocation, and HARQ information, associated with a DL-SCH. DCI on the PDCCH for scheduling UL transmission may include a UL scheduling grant that at least includes a modulation and coding format, resource allocation, and HARQ information, associated with a UL-SCH. HARQ information on a DL-SCH or UL-SCH may include a new information indicator (NDI), transport block size (TBS), redundancy version (RV), and HARQ process ID (i.e., HARQ process number). The size and usage of the DCI carried by one PDCCH differs according to a DCI format. For example, DCI format 00, DCI format 0_1, or DCI format 0_2 may be used to schedule the PUSCH, and DCI format 1_0, DCI format 1_1, or DCI format 12 may be used to schedule the PDSCH. Particularly, DCI format 0_2 and DCI format 12 may be used to schedule transmission having higher transmission reliability and lower latency requirements than transmission reliability and latency requirement guaranteed by DCI format 0_0, DCI format 0_1, DCI format 1_0, or DCI format 1_1. Some implementations of the present disclosure may be applied to UL data transmission based on DCL format 0_2. Some implementations of the present disclosure may be applied to DL data reception based on DCI format 1_2.

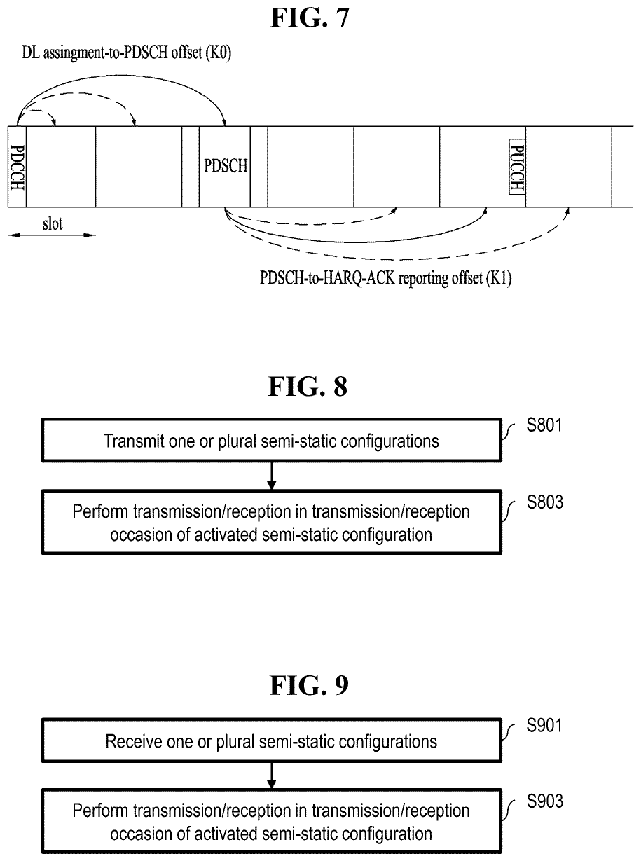

FIG. 7 illustrates an example of PDSCH TDRA caused by a PDCCH and an example of PUSCH TDRA caused by the PDCCH.

DCI carried by the PDCCH in order to schedule a PDSCH or a PUSCH includes a TDRA field. The TDRA field provides a value m for a row index m+1 to an allocation table for the PDSCH or the PUSCH. Predefined default PDSCH time domain allocation is applied as the allocation table for the PDSCH or a PDSCH TDRA table that the BS configures through RRC signaled pdsch-TimeDomainAllocationList is applied as the allocation table for the PDSCH. Predefined default PUSCH time domain allocation is applied as the allocation table for the PUSCH or a PUSCH TDRA table that the BS configures through RRC signaled pusch-TimeDomainAllocationList is applied as the allocation table for the PUSCH. The PDSCH TDRA table to be applied and/or the PUSCH TDRA table to be applied may be determined according a fixed/predefined rule (e.g., refer to 3GPP TS 38.214).

In PDSCH time domain resource configurations, each indexed row defines a DL assignment-to-PDSCH slot offset K₀, a start and length indicator value SLIV (or directly, a start position (e.g., start symbol index S) and an allocation length (e.g., the number of symbols, L) of the PDSCH in a slot), and a PDSCH mapping type. In PUSCH time domain resource configurations, each indexed row defines a UL grant-to-PUSCH slot offset K₂, a start position (e.g., start symbol index S) and an allocation length (e.g., the number of symbols, L) of the PUSCH in a slot, and a PUSCH mapping type. K₀ for the PDSCH and K₂ for the PUSCH indicate the difference between the slot with the PDCCH and the slot with the PDSCH or PUSCH corresponding to the PDCCH. SLIV denotes a joint indicator of the start symbol S relative to the start of the slot with the PDSCH or PUSCH and the number of consecutive symbols, L, counting from the symbol S. There are two PDSCH/PUSCH mapping types: one is mapping type A and the other is mapping type B. In the case of PDSCH/PUSCH mapping type A, a DMRS is mapped to a PDSCH/PUSCH resource with respect to the start of a slot. One or two of the symbols of the PDSCH/PUSCH resource may be used as DMRS symbol(s) according to other DMRS parameters. For example, in the case of PDSCH/PUSCH mapping type A, the DMRS is located in the third symbol (symbol #2) or the fourth symbol (symbol #3) in the slot according to RRC signaling. In the case of PDSCH/PUSCH mapping type B, a DMRS is mapped with respect to the first OFDM symbol of a PDSCH/PUSCH resource. One or two symbols from the first symbol of the PDSCH/PUSCH resource may be used as DMRS symbol(s) according to other DMRS parameters. For example, in the case of PDSCH/PUSCH mapping type B, the DMRS is located at the first symbol allocated for the PDSCH/PUSCH. In the present disclosure, the PDSCH/PUSCH mapping type may be referred to as a mapping type or a DMRS mapping type. For example, in the present disclosure, PUSCH mapping type A may be referred to as mapping type A or DMRS mapping type A, and PUSCH mapping type B may be referred to as mapping type B or DMRS mapping type B.

The scheduling DCI includes an FDRA field that provides assignment information about RBs used for the PDSCH or the PUSCH. For example, the FDRA field provides information about a cell for PDSCH or PUSCH transmission to the UE, information about a BWP for PDSCH or PUSCH transmission, and/or information about RBs for PDSCH or PUSCH transmission.

### *Resource Allocation by RRC

As mentioned above, there are two types of transmission without dynamic grant: configured grant Type 1 and configured grant Type 2. In configured grant Type 1, a UL grant is provided by RRC and stored as a configured UL grant. In configured grant Type 2, the UL grant is provided by the PDCCH and stored or cleared as the configured UL grant based on L1 signaling indicating configured UL grant activation or deactivation. Type 1 and Type 2 may be configured by RRC per serving cell and per BWP. Multiple configurations may be active simultaneously on different serving cells.

When configured grant Type 1 is configured, the UE may be provided with the following parameters through RRC signaling:
cs-RNTI corresponding to a CS-RNTI for retransmission;
periodicity corresponding to a periodicity of configured grant Type 1;
timeReferenceSFN that indicates a system frame number (SFN) used for determination of an offset of a resource in time domain;
timeDomainOffset is an offset related to SFN indicated by timeReferenceSFN;
timeDomainAllocation value m that provides a row index m+1 pointing to the allocation table, indicating a combination of the start symbol S, the length L, and the PUSCH mapping type;
frequencyDomainAllocation that provides frequency domain resource allocation; and
mcsAndTBS that provides IMCS indicating a modulation order, a target code rate, and a transport block size.

Upon configuration of configured grant Type 1 for a serving cell by RRC, the UE stores the UL grant provided by RRC as a configured UL grant for an indicated serving cell and initializes or re-initializes the configured UL grant to start in a symbol according to timeDomainOffset and S (derived from SLIV) and to recur with periodicity. After the UL grant is configured for configured grant Type 1, the UE may consider that the UL grant recurs in association with each symbol satisfying: [(SFN*numberOfSlotsPerFrame*numberOfSymbolsPerSlot+(slot number in the frame*numberOfSymbolsPerSlot)+symbol number in the slot]=(timeReferenceSFN*numberOfSlotsPerFrame*numberOfSymbolsPerSlot+timeDomainOffset*numberOfSymbolsPerSlot+S+N*periodicity) modulo (1024*numberOfSlotsPerFrame*numberOfSymbolsPerSlot), for N>=0, where numberOfSlotsPerFrame and numberOfSymbolsPerSlot indicate the number of consecutive slots per frame and the number of consecutive OFDM symbols per slot, respectively (refer to Table 1 and Table 2).

For configured grant Type 2, the UE may be provided with the following parameters by the BS through RRC signaling:
cs-RNTI corresponding to a CS-RNTI for activation, deactivation, and retransmission; and
periodicity that provides a periodicity of configured grant Type 2.

An actual UL grant is provided to the UE by the PDCCH (addressed to the CS-RNTI). After the UL grant is configured for configured grant Type 2, the UE may consider that the UL grant recurs in association with each symbol satisfying: [(SFN*numberOfSlotsPerFrame*numberOfSymbolsPerSlot)+(slot number in the frame*numberOfSymbolsPerSlot)+symbol number in the slot]=[(SFN_{start time}*numberOfSlotsPerFrame*numberOfSymbolsPerSlot+slot_{start time}*numberOfSymbolsPerSlot+symbol_{start time})+N*periodicity] modulo (1024*numberOfSlotsPerFrame*numberOfSymbolsPerSlot), for all N>=0, where SFN_{start time}, slot_{start time}, and symbol_{start time} represent an SFN, a slot, and a symbol, respectively, of the first transmission opportunity of the PUSCH after the configured grant is (re-)initialized, and numberOfSlotsPerFrame and numberOfSymbolsPerSlot indicate the number of consecutive slots per frame and the number of consecutive OFDM symbols per slot, respectively (refer to Table 1 and Table 2).

ConfiguredGrantConfig, an RRC configuration used to configure a configured grant Type 1 or Type 2, may include configuredGrantTimer, a parameter indicating an initial value of a grant timer configured to a multiple of periodicity.

In some scenarios, a parameter harq-ProcID-Offset and/or a parameter harq-ProcID-Offset2 used to derive HARQ process IDs for configured UL grants may be further provided by the BS to the UE. harq-ProcID-Offset is an offset of a HARQ process for a configured grant for operation with shared spectrum channel access, and harq-ProcID-Offset2 is an offset of a HARQ process for a configured grant. In the present disclosure, cg-RetransmissionTimer is a duration after (re)transmission based on a configured grant in which the UE should not autonomously perform retransmission based on the HARQ process of the (re)transmission. cg-RetransmissionTimer may be provided to the UE by the BS when retransmission on a configured UL grant is configured. For configured grants configured with neither harq-ProcID-Offset nor cg-RetransmissionTimer; the HARQ process ID associated with the first symbol of UL transmission may be derived from the following equation: HARQ Process ID=[floor(CURRENT_symbol/periodicity)] modulo nrofHARQ-Processes. For configured UL grants with harq-ProcID-Offset2, the HARQ process ID associated with the first symbol of UL transmission may be derived from the following equation: HARQ Process ID=[floor(CURRENT_symbol/periodicity)] modulo nrofHARQ-Processes+harq-ProcID-Offset2, where CURRENT_symbol=(SFN*numberOfSlotsPerFrame*numberOfSymbolsPerSlot+slot number in the frame*numberOfSymbolsPerSlot+symbol number in the slot), and numberOfSlotsPerFrame and numberOfSymbolsPerSlot denote the number of consecutive slots per frame and the number of consecutive OFDM symbols per slot, respectively. For configured UL grants with cg-RetransmissionTimer, the UE may select a HARQ process ID from among HARQ process IDs available for the configured grant configuration.

On DL, the UE may be configured with semi-persistent scheduling (SPS) per serving cell and per BWP by RRC signaling from the BS. For DL SPS, DL assignment is provided to the UE by the PDCCH and stored or cleared based on L1 signaling indicating SPS activation or deactivation. When SPS is configured, the UE may be provided with the following parameters by the BS through RRC signaling (e.g., SPS configuration) used to configure a semi-persistent transmission:
cs-RNTI corresponding to a CS-RNTI for activation, deactivation, and retransmission;
nrofHARQ-Processes that provides the number of HARQ processes for SPS;
periodicity that provides a periodicity of configured DL assignment for SPS;
n1PUCCH-AN that provides a HARQ resource for a PUCCH for SPS (the network configures the HARQ resource as format 0 or format 1, and the actual PUCCH resource is configured by PUCCH-Config and referred to in n1PUCCH-AN by the ID thereof).

Multiple DL SPS configurations may be configured within the BWP of a serving cell. After DL assignment is configured for SPS, the UE may consider sequentially that N-th DL assignment occurs in a slot satisfying: (numberOfSlotsPerFrame*SFN+slot number in the frame)=[(numberOfSlotsPerFrame*SFN_{start time}+slot_{start time})+N*periodicity*numberOfSlotsPerFrame/10] modulo (1024*numberOfSlotsPerFrame), where SFN_{start time} and slot_{start time} represent an SFN and a slot, respectively, of first transmission of the PDSCH after configured DL assignment is (re-)initialized, and numberOfSlotsPerFrame and numberOfSymbolsPerSlot indicate the number of consecutive slots per frame and the number of consecutive OFDM symbols per slot, respectively (refer to Table 1 and Table 2).

In some scenarios, a parameter harq-ProcID-Offset used to derive HARQ process IDs for configured DL assignments may be further provided by the BS to the UE. harq-ProcID-Offset is an offset of a HARQ process for SPS. For configured DL assignments without harq-ProcID-Offset, a HARQ process ID associated with a slot in which DL transmission starts may be determined from the following equation: HARQ Process ID=[floor (CURRENT_slot*10/(numberOfSlotsPerFrame*periodicity))] modulo nrofHARQ-Processes, where CURRENT_slot=[(SFN*numberOfSlotsPerFrame)+slot number in the frame], and numberOfSlotsPerFrame denotes the number of consecutive slots per frame. For configured DL assignments with harq-ProcID-Offset, a HARQ process ID associated with a slot in which DL transmission starts may be determined from the following equation: HARQ Process ID=[floor (CURRENT_slot/periodicity)] modulo nrofHARQ-Processes+harq-ProcID-Offset, where CURRENT_slot=[(SFN*numberOfSlotsPerFrame)+slot number in the frame], and numberOfSlotsPerFrame denotes the number of consecutive slots per frame.

If the CRC of a corresponding DCI format is scrambled with the CS-RNTI provided by the RRC parameter cs-RNTI, and a new data indicator field for an enabled transport block is set to 0, the UE validates, for scheduling activation or scheduling release, a DL SPS assignment PDCCH or a configured UL grant Type 2 PDCCH. Validation of the DCI format is achieved if all fields for the DCI format are set according to Table 5 and Table 6. Table 5 shows an example of special fields for DL SPS and UL grant Type 2 scheduling activation PDCCH validation, and Table 6 shows an example of special fields for DL SPS and UL grant Type 2 scheduling release PDCCH validation.

TABLE 5

| | DCI format | DCI format | |
|---|---|---|---|
| | 0_0/0_1 | 1_0 | DCI format 1_1 |
| HARQ process | set to all ‘0’s | set to all ‘0’s | set to all ‘0’s |
| number | | | |
| Redundancy | set to ‘00’ | set to ‘00’ | For the enabled transport |
| version | | | block: set to ‘00’ |

TABLE 6

| | DCI format 0_0 | DCI format 1_0 |
|---|---|---|
| HARQ process number | set to all ‘0’s | set to all ‘0’s |
| Redundancy version | set to ‘00’ | set to ‘00’ |
| Modulation and coding scheme | set to all ‘1’s | set to all ‘1’s |
| Resource block assignment | set to all ‘1’s | set to all ‘1’s |

Actual DL assignment and UL grant for DL SPS or UL grant Type 2, and a corresponding MCS are provided by resource assignment fields (e.g., a TDRA field providing a TDRA value m, an FDRA field providing frequency resource block assignment, and/or an MCS field) in the DCI format carried by a corresponding DL SPS or UL grant Type 2 scheduling activation PDCCH. If validation is achieved, the UE considers information in the DCI format as valid activation or valid release of DL SPS or configured UL grant Type 2.

In the present disclosure, a PDSCH based on DL SPS may be referred to as an SPS PDSCH, and a PUSCH based on a UL configured grant (CG) may be referred to as a CG PUSCH. A PDSCH dynamically scheduled by DCI carried on a PDCCH may be referred to as a dynamic grant (DG) PDSCH, and a PUSCH dynamically scheduled by DCI carried by on a PDCCH may be referred to as a DG PUSCH.

FIG. 7 illustrates a HARQ-ACK transmission/reception procedure.

Referring to FIG. 7, the UE may detect a PDCCH in a slot n. Next, the UE may receive a PDSCH in a slot n+K0 according to scheduling information received through the PDCCH in the slot n and then transmit UCI through a PUCCH in a slot n+K1. In this case, the UCI includes a HARQ-ACK response for the PDSCH.

The DCI (e.g., DCI format 1_0 or DCI format 1_1) carried by the PDCCH for scheduling the PDSCH may include the following information.
Frequency domain resource assignment (FDRA): FDRA indicates an RB set allocated to the PDSCH.
Time domain resource assignment (TDRA): TDRA indicates a DL assignment-to-PDSCH slot offset K0, the start position (e.g., symbol index S) and length (e.g., the number of symbols, L) of the PDSCH in a slot, and the PDSCH mapping type. PDSCH mapping Type A or PDSCH mapping Type B may be indicated by TDRA. For PDSCH mapping Type A, the DMRS is located in the third symbol (symbol #2) or fourth symbol (symbol #3) in a slot. For PDSCH mapping Type B, the DMRS is allocated in the first symbol allocated for the PDSCH.
PDSCH-to-HARQ_feedback timing indicator: This indicator indicates K1.

If the PDSCH is configured to transmit a maximum of one TB, a HARQ-ACK response may consist of one bit. If the PDSCH is configured to transmit a maximum of 2 TBs, the HARQ-ACK response may consist of 2 bits when spatial bundling is not configured and one bit when spatial bundling is configured. When a HARQ-ACK transmission timing for a plurality of PDSCHs is designated as slot n+K1, UCI transmitted in slot n+K1 includes a HARQ-ACK response for the plural PDSCHs.

In the present disclosure, a HARQ-ACK payload consisting of HARQ-ACK bit(s) for one or plural PDSCHs may be referred to as a HARQ-ACK codebook. The HARQ-ACK codebook may be categorized as i) a semi-static HARQ-ACK codebook, ii) a dynamic HARQ-ACK codebook and iii) HARQ process based HARQ-ACK codebook, according to a HARQ-ACK payload determination scheme.

In the case of the semi-static HARQ-ACK codebook, parameters related to a HARQ-ACK payload size that the UE is to report are semi-statically determined by a (UE-specific) higher layer (e.g., RRC) signal. The HARQ-ACK payload size of the semi-static HARQ-ACK codebook, e.g., the (maximum) HARQ-ACK payload (size) transmitted through one PUCCH in one slot, may be determined based on the number of HARQ-ACK bits corresponding to a combination (hereinafter, bundling window) of all DL carriers (i.e., DL serving cells) configured for the UE and all DL scheduling slots (or PDSCH transmission slots or PDCCH monitoring slots) for which the HARQ-ACK transmission timing may be indicated. That is, in a semi-static HARQ-ACK codebook scheme, the size of the HARQ-ACK codebook is fixed (to a maximum value) regardless of the number of actually scheduled DL data. For example, DL grant DCI (PDCCH) includes PDSCH-to-HARQ-ACK timing information, and the PDSCH-to-HARQ-ACK timing information may have one (e.g., k) of a plurality of values. For example, when the PDSCH is received in slot #m and the PDSCH-to-HARQ-ACK timing information in the DL grant DCI (PDCCH) for scheduling the PDSCH indicates k, the HARQ-ACK information for the PDSCH may be transmitted in slot #(m+k). As an example, k∈{1, 2, 3, 4, 5, 6, 7, 8}. When the HARQ-ACK information is transmitted in slot #n, the HARQ-ACK information may include possible maximum HARQ-ACK based on the bundling window. That is, HARQ-ACK information of slot #n may include HARQ-ACK corresponding to slot #(n−k). For example, when k∈{1, 2, 3, 4, 5, 6, 7, 8}, the HARQ-ACK information of slot #n may include HARQ-ACK corresponding to slot #(n−8) to slot #(n−1) regardless of actual DL data reception (i.e., HARQ-ACK of a maximum number). Here, the HARQ-ACK information may be replaced with a HARQ-ACK codebook or a HARQ-ACK payload. A slot may be understood/replaced as/with a candidate occasion for DL data reception. As described in the example, the bundling window may be determined based on the PDSCH-to-HARQ-ACK timing based on a HARQ-ACK slot, and a PDSCH-to-HARQ-ACK timing set may have predefined values (e.g., {1, 2, 3, 4, 5, 6, 7, 8}) or may be configured by higher layer (RRC) signaling. The semi-static HARQ-ACK codebook is referred to as a Type-1 HARQ-ACK codebook. For the Type-1 HARQ-ACK codebook, the number of bits to be transmitted in a HARQ-ACK report is fixed and may be potentially large. If many cells are configured but only few cells are scheduled, the Type-1 HARQ-ACK codebook may be inefficient.

In the case of the dynamic HARQ-ACK codebook, the HARQ-ACK payload size that the UE is to report may be dynamically changed by the DCI etc. The dynamic HARQ-ACK codebook is referred to as a Type-2 HARQ-ACK codebook. The Type-2 HARQ-ACK codebook may be considered as optimized HARQ-ACK feedback because the UE sends feedback only for scheduled serving cells. However, in poor channel conditions, the UE may erroneously determine the number of scheduled serving cells. To solve this problem, a downlink assignment index (DAI) may be included as a part of DCI. For example, in the dynamic HARQ-ACK codebook scheme, DL scheduling DCI may include a counter-DAI (i.e., c-DAI) and/or a total-DAI (i.e., t-DAI). Here, the DAI indicates a downlink assignment index and is used for the BS to inform the UE of transmitted or scheduled PDSCH(s) for which HARQ-ACK(s) are to be included in one HARQ-ACK transmission. Particularly, the c-DAI is an index indicating order between PDCCHs carrying DL scheduling DCI (hereinafter, DL scheduling PDCCHs), and t-DAI is an index indicating the total number of DL scheduling PDCCHs up to a current slot in which a PDCCH with the t-DAI is present.

In the case of a HARQ-ACK codebook based on HARQ processes, the HARQ-ACK payload is determined based on all HARQ processes of all configured (or activated) serving cells in a PUCCH group. For example, the size of the HARQ-ACK payload to be reported by the UE using the HARQ-ACK codebook based on HARQ processes may be determined based on the number of all configured or activated serving cells in the PUCCH group configured for the UE and the number of HARQ processes for the serving cells. The HARQ-ACK codebook based on HARQ processes is also referred to as a Type-3 HARQ-ACK codebook. The type-3 HARQ-ACK codebook may be applied to one-shot feedback.

Extended reality (XR) is an ultra-immersive technology and service that provides an environment in which the users are capable of communicating and living without restrictions on time and space in a virtual space similar to reality by utilizing virtual reality (VR), augmented reality (AR), mixed reality (MR), holography, etc. XR is one of major services to be introduced in an NR wireless communication system. XR is typically characterized by specific traffic with one or more DL video streams which are closely synchronized with frequent UL pose/control updates. XR has a high data rate and a strict packet delay budget (PDB). The PDB defines an upper bound for the time that a packet may be delayed between a UE and a user plane function (UPF) of a core network. In other words, the PDB may be a value regarding the upper bound of the time during which a generated packet needs to be transmitted.

Successful implementation of the XR requires support from a wireless system. In a 3GPP-based wireless communication system, e.g., an NR wireless communication system, it is considered to utilize pre-configured resources such as SPS/CG to support the XR. For example, the BS may provide SPS/CG configurations to the UE in consideration of an average inter-arrival time of packets. However, an actual inter-arrival time of packets is random due to jitter. Jitter means an unwanted deviation in time for a periodic signal. The amount of information per frame in the XR is different, and thus a time required to process frames before transmitting the frames is different, resulting in jitter. Therefore, even if SPS/CG resources that occur at regular intervals are configured to the UE, the UE may not be capable of performing PDSCH reception/PUSCH transmission at the PDSCH occasion/PUSCH occasion due to jitter.

Hereinafter, some implementations of the present disclosure are described that dynamically change the configured radio resources and interact with other dynamic scheduling when a UE is provided with a plurality of services and one service uses a plurality of semi-static configurations (e.g., SPS or configured grants).

In NR, one or more SPS PDSCHs or CG PUSCHs may be configured for the UE for periodic transmission and reception or for low latency and PDCCH overhead. The corresponding configuration/indicated resource may recur in the time domain with a periodicity according to each SPS/CG configuration. For example, the initially configured/indicated resource allocation may be repeated with a periodicity configured according to the SPS/CG configuration, and the UE may perform DL reception/UL transmission in the corresponding resource without a separate PDCCH reception process. The types of data to be generated in the XR are diverse. From among these data, it is considered that transmissions of information regarding a UE sensor and location thereof and video data, which are generally reported with a specific periodicity, are transmitted and received in SPS/CG resources. These data may have irregular traffic arrival times and jitter due to reasons such as video encoding time, sensor measurement time, higher layer operation, or routing changes in a network through which the data is transmitted.

Resource allocation through dynamic scheduling may be considered for XR services. When using latency-sensitive XR services, measures need to be considered to ensure that the corresponding transmission is not canceled by other transmission. The UE needs to receive DL assignments and/or UL grants appropriate to the service.

In the NR, priorities at a PHY layer are introduced for a plurality of services, which allows the UE to perform UL transmission or DL reception by using only one of overlapping radio resources or to divide the overlapping UL transmission into a plurality of groups to perform UL multiplexing. Low priority transmissions may be canceled during this process, and thus measures to prevent XR transmissions from being canceled need to be considered. The XR has the characteristic of displaying an image on a screen accurately over time, and thus previous data may become useless once a time by which XR data is required to be provided passes.

If the BS allocates a resource at a location that is sufficiently distant in time from an expected time at which traffic is generated in consideration of jitter at a data generation time, resource availability may be ensured, but a delay time may occur. On the contrary, when the SPS/CG resource with a fixed periodicity is assigned at the expected time at which data is generated, a larger delay time may occur due to a waiting time to a next available resource when jitter occurs.

Some data is generated based on an event, and thus it is impossible to accurately determine the time at which data is actually generated, but it is considered to use SPS/CG resources for such data to reduce a delay time caused by scheduling. In this case, skipping method(s) may be considered, in which a network allocates sufficient resources with a short periodicity to prepare for data generation, and the UE or the BS selectively uses some of these resources and does not actually use other resource(s). However, to use the skipping method of transmission and reception, the UE and the BS need to carefully consider response signals between the UE and the BS to determine whether to perform reception and/or transmission. When the UE needs to transmit a response signal even for transmissions that the UE does not receive, the BS needs to always prepare for resources in which the UE transmits the response signal. Considering that the skipping method is based on configuring sufficient resources within radio resources, configuring resources to allow the UE to transmit a response signal even for transmissions the UE does not receive may act as a large UL burden. Considering that these resources are capable of being multiplexed between UEs, the burden of UL resources needs to be considered more importantly.

The above matters need to considered when using an XR service or a similar third-party service. For example, in some implementations of the present disclosure, UE operation that dynamically changes radio resources of SPS PDSCH and CG PUSCH may be considered to effectively transmit information such as video of which a payload size of various services or traffic dynamically changes. Hereinafter, some implementations of the present disclosure that dynamically change semi-static configurations to be associated with an XR service, as well as some implementations of the present disclosure that processes an interaction of dynamic scheduling with semi-static configurations will be described.

Hereinbelow, while implementations of the present disclosure are described based on DL SPS and UL CG radio resources, which are semi-statically configured, the implementations of the present disclosure are not limited thereto and may be extensively applied to radio resources allocated through dynamic scheduling received by the UE. As an example, the implementation(s) of the present disclosure in which the UE determines one HARQ-ACK timing for a plurality of DL radio resources allocated thereto may be applied regardless of an SPS PDSCH and a PDSCH which is indicated by dynamic scheduling. Additionally, when a plurality of radio resources is not configured semi-statically and is configured through dynamic indication, for example, even when a plurality of radio resources is simultaneously configured through DCI, the implementations of the present disclosure may be applied. Therefore, the implementations of the present disclosure may be applied to all types of transmission/reception methods expected by the BS and the UE even if there is no separate explanation. Hereinafter, for convenience of description, the implementations of the present disclosure are described using SPS as a general term that collectively refers to semi-statically configured radio resources (e.g., DL/UL SPS and CG).

In some implementations of the present disclosure, a transmission occasion (TO) may refer to a radio resource configured for SPS/CG (e.g., an SPS PDSCH or a CG PUSCH). In the present disclosure, the term transmission occasion may be used interchangeably with the term transmission opportunity. An entity performing transmission in a TO (e.g., a BS on DL or a UE on UL) may attempt to perform transmission in the TO, and a receiver (e.g., a UE on DL or a BS on UL) may attempt to perform reception while expecting that there will be transmission in each TO.

Hereinbelow, while the implementations of the present disclosure will be described based on the NR system, the implementations of the present disclosure are not limited to the transmission/reception of NR. Additionally, while, in the present disclosure, the implementations of the present disclosure are described using characteristics and structures of the XR service as an example, the implementations of the present disclosure are not limited to support of the XR service. The implementations of the present disclosure may be applied to all wireless communication transmission/reception structures and services even without separate description.

The present disclosure describes implementations for activating/deactivating semi-static configuration. For example, implementations of the present disclosure may include a method for a BS to allocate PDSCH/PUSCH radio resource(s) to a UE, and a method for the UE to perform DL reception or UL reception on the allocated radio resources. Some implementations of the present disclosure may include a method for the UE to transmit a HARQ-ACK PUCCH response to a PDSCH reception result, and a method of receiving retransmission DCI of the BS via a PDCCH after PUSCH transmission. In some implementations of the present disclosure, the UE may transmit signals and channels for indicating its capabilities and/or service requirements and the BS may receive the signals and the channels.

FIG. 8 illustrates a flow of a UE operation to which some implementations of the present disclosure are applicable, and FIG. 9 illustrates a flow of a BS operation to which some implementations of the present disclosure are applicable.

The BS may provide one or plurality of semi-static configurations (e.g., SPS configuration(s), CG configuration(s) and/or SG configuration(s)) through RRC signaling (S801). The UE may receive, from the BS, one or plurality of semi-static configurations (e.g., SPS configuration(s), CG configuration(s) and/or SG configuration(s)) through RRC signaling (S901). The semi-static configuration that are configured may be automatically activated or initially deactivated. The one or plurality of semi-static configurations may be activated and/or deactivated according to some implementations of the present disclosure. For example, the one or plurality of semi-static configurations may be activated/deactivated through L1 signaling (e.g., DCI) and/or higher layer signaling (e.g., RRC signaling or MAC control element) of the BS, when transmission or reception is performed in a transmission opportunity or SR opportunity of a specific semi-static configuration, other semi-static configurations may be activated/deactivated for a certain period of time or continuously, or a group of configurations may be activated/deactivated based on a separately semi-statically configured or dynamically indicated activation/deactivation pattern. The UE may receive/transmit a PDSCH/PUSCH or transmit an SR PUCCH in a reception opportunity of the activated SPS, a transmission opportunity of CG, or an SR opportunity (S903), and may not receive/transmit the PDSCH/PUSCH or transmit the SR PUCCH in the transmission opportunity of deactivated SPS, CG, SR or SR opportunity. The BS may transmit/receive a PDSCH/PUSCH or receive an SR PUCCH in a transmission opportunity of the activated SPS, a reception opportunity of CG, or an SR opportunity (S803), and assuming that the BS is not capable of transmitting/receiving the PDSCH/PUSCH or receive the SR PUCCH in the transmission opportunity of deactivated SPS, CG, SR or SR opportunity, the BS may perform a UL reception operation. In some implementations, the UE may assume that the deactivated semi-static configuration is not configured.

The activation/deactivation may be performed separately from the existing SPS/CG activation/deactivation. For example, unlike the existing SPS/CG activation/deactivation that newly allocates resources and releases allocated resource information, in some implementations of the present disclosure, activation/deactivation of semi-static configuration may maintain resource allocation information for determining the transmission opportunity or SR opportunity of each configuration and restrict only transmission and reception in the transmission opportunity/SR opportunity of the corresponding configuration.

Some implementations of the present disclosure may be selectively applied in part. Some implementations of the present disclosure may be performed independently without combination with other implementations, or one or more implementations may be combined and performed in an associated form. Some terms, symbols, sequences, etc. used in the present disclosure may be replaced with other terms, symbols, sequences, etc. as long as the principle of implementations of the present disclosure is maintained.

Some implementations of the present disclosure may be specified to be applied only when the UE receives relevant configuration information from the BS (or core network). In this case, the configuration information may be provided through higher layer signaling (e.g., SIB or RRC signaling). Alternatively, separate signaling (e.g., DCI or MAC control element) indicating the activation or deactivation of corresponding configuration(s) may be used along with the configuration information. In some implementations of the present disclosure, the UE may report information (e.g., capability information) regarding whether the UE is capable of supporting a method according to the implementation, and the BS (or core network) may receive the information.

### <Implementation 1: Semi-Static Configuration Adaptation by Re-Transmission Scheduling>

When the UE performs retransmission for a semi-statically configured SPS PDSCH or CG PUSCH, the UE may change the associated SPS or configured grant configurations and radio resources based on DCI that schedules radio resources required for the retransmission.

For example, the UE may receive a retransmission scheduling message from the BS via the DCI after receiving the SPS PDSCH or transmitting the CG PUSCH. The UE may change the radio resources of the SPS/CG configuration associated with the retransmission based on the received DCI.

The radio resource to be newly changed is a radio resource for retransmission scheduled by the retransmission scheduling DCI, or information indicating one of the radio resources (or radio resource sets) previously configured from the BS through LI signaling (e.g., DCI) and/or higher layer signaling (e.g., RRC signaling), such as a radio resource update indicator DCI field is included in the retransmission scheduling DCI and transmitted, and the UE may change the radio resource (set) of the associated SPS/CG configuration to one of the configured radio resources (or radio resource sets) based on the information of the received radio resource update indicator.

The changed radio resource may be applied from a time of reception/transmission end in the radio resource scheduled by the retransmission scheduling DCI, or a time of transmitting an ACK for successful reception of a PDSCH in the case of the PDSCH, in consideration of a processing time of the UE. For example, when the UE receives an SPS PDSCH and transmits NACK information indicating reception failure thereof through a PUCCH, the BS may transmit retransmission DCI to the UE, and when the UE successfully receives the PDSCH based on the retransmission DCI, the UE may transmit an ACK message indicating successful reception thereof through the PUCCH, and after successful transmission, change a radio resource of the SPS PDSCH to a PDSCH radio resource scheduled by the retransmission DCI. That is, a previously indicated/configured SPS PDSCH or CG PUSCH is no longer used from the corresponding point in time, and radio resource information newly indicated through the retransmission DCI or radio resource information provided through a radio resource update indicator, such as frequency-domain resource allocation (FDRA), time-domain resource allocation (TDRA), modulation and coding scheme (MCS) information, may be repeated and used based on a periodicity of the SPS configuration.

In some implementations, this change may be temporary to be adapted to traffic changes. That is, after the UE changes the radio resource through implementation 1, the UE may change back to a preconfigured/instructed radio resource after a certain period of time. The certain period of time may be a periodicity of an associated semi-static configuration or N times the periodicity. Alternatively, the change may be applied only for a certain period of time. In this case, the certain period of time may be based on the number of times the changed radio resource is used/generated. For example, the certain period of time may be defined as a time during which the changed radio resource is generated 1, 2 or N times, and N may be provided via L1 signaling and/or higher layer signaling of the BS. In particular, when a plurality of radio resources (i.e., multi-PUSCH/PDSCH) within a periodicity are scheduled using the retransmission DCI, the changed radio resource may be used until all of the plurality of radio resources within the periodicity are used/generated once.

When the resource change is temporary, the UE may assume that the resource change does not affect determination of the HARQ process ID. In this case, the HARQ process ID is determined based on the TDRA information of the radio resource before the resource change, and in this case, the HARQ process ID of the changed radio resource may be the HARQ process ID of the radio resource before the change at the closest previous point in time to the radio resource. Alternatively, the HARQ process ID of the radio resource before the change, which is present in the same slot, may be used.

### <Implementation 2: Semi-Static Configuration Adaptation by Re-Initialization/Activation>

The BS may re-activate the pre-configured and activated radio resources through activation DCI to change the radio resources of the semi-static configuration of the UE. A UE that receives previous activation DCI may release previous radio resources according to the provided activation DCI and re-configure radio resources according to the given activation DCI. When re-activating a semi-static configuration that is activated as such to change the existing radio resources, a problem may occur in which the transmission/reception of a transport block being transmitted on the associated HARQ process through the pre-indicated/configured radio resources is flushed due to new transmissions before the transport block is completely terminated. To avoid these problems, at least the following may be considered.
When an activated semi-static configuration is re-activated without being deactivated, no new transmission may be performed for a transmission opportunity corresponding to a HARQ process associated with a transport block that is previously being transmitted until the transmission of the transport block that is previously being transmitted is terminated.
   For example, a CG timer that starts due to start of transmission of a transport block that is previously being transmitted may be maintained.
   As another example, it may be regulated that transmission via a semi-static configuration is only possible for the HARQ process after the PDB of the transport block that is previously being transmitted expires.
   As another example, it may be regulated that transmission via a semi-static configuration that is activated again for the corresponding HARQ process is possible only after a certain period of time elapses since transmission/reception of the transport block that is previously being transmitted. The certain period of time may be a value determined by the capability of the UE or a value provided through L1 signaling and/or higher layer signaling of the BS.
   As another example, it may be regulated that transmission via a semi-static configuration that is activated again for the corresponding HARQ process is possible only after the transport block that is previously being transmitted is received and then a successful transmission response is transmitted for the corresponding transport block.
   As another example, it may be regulated that transmission via a semi-static configuration that is activated again for the corresponding HARQ process is possible only after the transport block that is previously being transmitted is received and then a successful transmission response is transmitted for the corresponding transport block.
When an activated semi-static configuration is re-activated without being deactivated, retransmission of a transport block that is previously being transmitted may be performed for the first time in a transmission occasion only if the transmission occasion corresponding to the HARQ process associated with the transport block that is previously being transmitted may be used to transmit a transport block size that is the same as that of the transport block that is previously being transmitted.

### <Implementation 3: Re-Transmission Based on PDB Information>

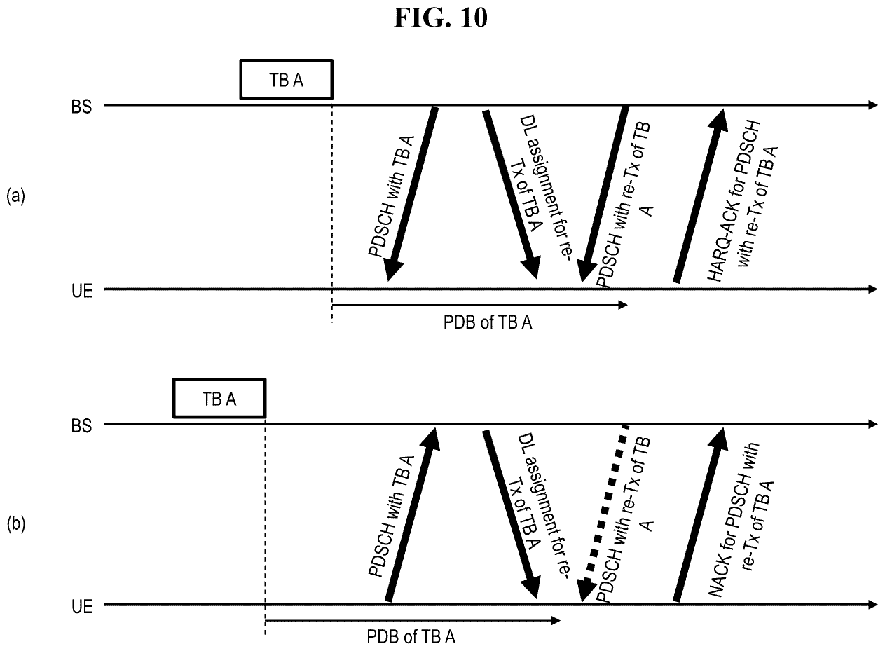

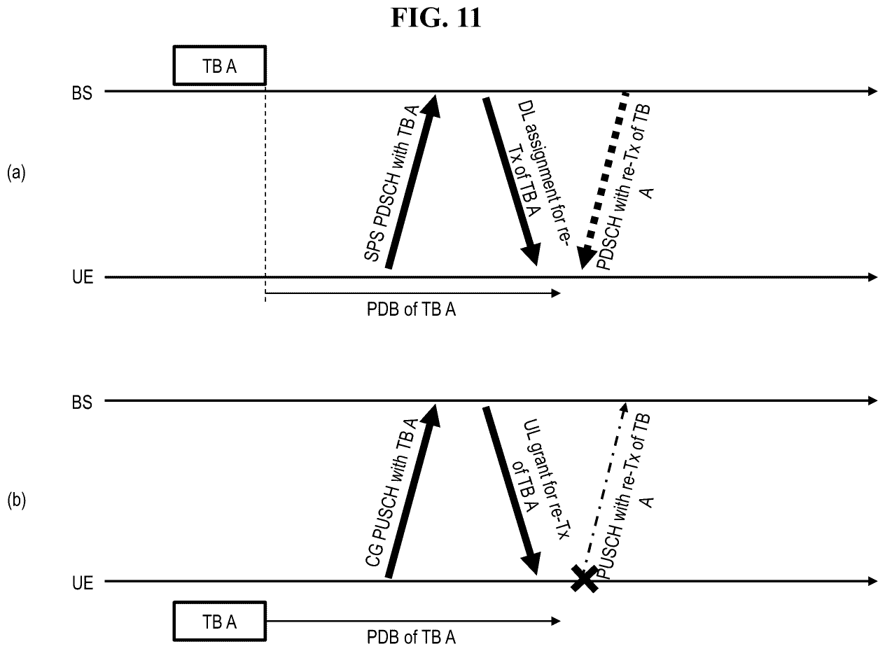

FIGS. 10 and 11 illustrate PDB-based retransmission related operations according to some implementations of the present disclosure.

To support an XR service, a UE or a BS may define the maximum available delay time of a packet being transmitted, or in other words, a packet delay budget (PDB). For example, when information such as a video is transmitted, if the video information of a certain point in time is already transmitted and reproduced, the video information of a point in time before the corresponding point in time may not be necessary. For information related to a location sensor, when the latest information is transmitted/received, location information from a previous point in time may not be necessary. In some implementations of the present disclosure, the UE or the BS may receive information on a lifetime of this information as PDB information via L1 signaling and/or higher layer signaling. For example, in UL, the UE may receive PDB information from a higher layer of its protocol stack and provide the PDB information to the BS through a scheduling request (SR) or a buffer status report (BSR). In DL, the BS may receive PDB information from a higher layer of its protocol stack and use DL allocation to share the PDB information with the UE. This PDB information may be based on each logical channel on the MAC layer. For example, in UL, when the BS configures a PDB for each logical channel, or when the UE notifies the BS (via BSR or the like) of a logical channel or logical channel group of UL data that is available for transmission, the BS may provide the PDB together with the corresponding PDB, or when the UE notifies the BS (via BSR or the like) of a logical channel or logical channel group of UL data that is available for transmission from the UE, the BS may provide the UE with a UL grant for UL data of the logical channel or logical channel group together with the PDB. Alternatively, this PDBH information may be based on a transport block (TB) generated at a MAC layer, or may be based on a packet given by a higher layer (e.g., RLC layer, PDCP layer, or application layer). Based on this PDB information, the UE may terminate the associated transmission or request a retransmission. For example, the following operation may be considered.

Referring to FIG. 10(b), when a UE receives a PDSCH, if the PDB of a TB associated with the received PDSCH expires (i.e., if a time equivalent to the PDB passes since a time when the corresponding TB is generated), the UE may transmit a NACK indicating reception failure regardless of the reception result of the PDSCH. Alternatively, although not shown, as another example, an ACK may always be transmitted indicating successful reception regardless of the PDSCH reception result such that no further retransmissions occur. Referring to FIG. 10(a), when the PDB of a TB associated with a PDSCH received by the UE does not expire, the UE may transmit HARQ-ACK information of ACK or NACK for the PDSCH based on the reception result of the PDSCH, i.e., the decoding result.

Referring to FIG. 11, when the UE performs re-reception/retransmission for a semi-statically configured SPS PDSCH or CG PUSCH, if a packet delay budget (PDB) of previous transmission expires, the UE may disregard the retransmission DCI scheduling the re-reception/retransmission and assume that the retransmission is not received. Accordingly, the UE may not attempt to receive/decode the PDSCH if the retransmission DCI schedules the PDSCH (see FIG. 11(a)), and may not perform PUSCH transmission if the retransmission DCI schedules the PUSCH (see FIG. 11(b)). Although not shown, the UE may perform conventional operations of receiving or transmitting the TB of the previous transmission based on the retransmission DCI if the PDB of the previous transmission does not expire. In other words, in some implementations of the present disclosure, the UE may determine the validity of scheduling from the BS based on the PDB information. Taking a CG PUSCH as an example, the BS may schedule, by using DCI, retransmission for a TB transmitted through the CG PUSCH by the UE. The BS may schedule, by the DCI of the CS-RNTI, retransmission for the TB transmitted through the CG PUSCH. The UE may know the TB for which retransmission is required based on the HARQ process ID and NDI value in the DCI. For example, if a HARQ process ID in the DCI with CRC scrambled with CS-RNTI is the same as the HARQ process ID used for a TB previously transmitted via a CG PUSCH and the NDI value is indicated as ‘1’, the UE may determine that the DCI is retransmission DCI scheduling retransmission of the TB. The UE may disregard the retransmission DCI when the PDB of the TB expires and may perform retransmission of the TB on time-frequency resources according to the retransmission DCI when the PDB of the TB does not expire. If the PDB of the TB does not expire, retransmission is performed based on the retransmission DCI. (Whether to retransmit according to the retransmission DCI is determined based on whether the PDB of the TB expires). Taking a SPS PDSCH as an example, the BS may schedule retransmission for the TB transmitted through the SPS PDSCH via the DCI. The UE may determine whether the DCI is the retransmission DCI based on the HARQ process ID and NDI value in the DCI. For example, if the HARQ process ID in the DCI scheduling the PDSCH is the same as the HARQ process ID of the TB previously transmitted via the SPS PDSCH by the UE and the NDI value is indicated as ‘1’, the UE may determine that the DCI is the retransmission DCI scheduling retransmission of the TB. The UE may disregard the retransmission DCI and may not decode the PDSCH scheduled by the retransmission DCI if the PDB of the TB expires. The UE may decode the PDSCH scheduled by the retransmission DCI if the PDB of the TB does not expire. In some implementations of the present disclosure, when the PDB of the TB expires, the BS may not transmit the DCI for retransmission of the TB. In some implementations of the present disclosure, if the PDB of the TB expires, the UE may not expect to receive the retransmission DCI related to the corresponding TB from the BS. FIG. 11(b) illustrates a case in which the PDB of a given TB expires after reception of the retransmission DCI and before the PDSCH occasion due to the retransmission DCI, but even if the PDB of the given TB expires before reception of the retransmission DCI, the UE may disregard the retransmission DCI and consider the retransmission DCI as not being received. The BS may or may not transmit the retransmission DCI for PDSCH transmission or PUSCH reception assuming that the UE operates in this manner, and even the BS transmits the retransmission DCI, the UE may assume that the UE skips PDSCH reception or PUSCH transmission according to the DL assignment or UL grant provided by the retransmission DCI. For example, it is difficult for the BS to know when the TB transmitted by the UE via a PUSCH is generated by the UE, and thus it is difficult for the BS to know the exact time when the PDB of the TB expires unless the UE separately informs the exact time. Therefore, even if the BS transmits the retransmission DCI for the TB transmitted by the UE via the PUSCH, the BS may attempt to receive the retransmission PUSCH under assumption that the UE disregards the retransmission DCI and may not transmit the retransmission PUSCH in the time-frequency resources allocated by the retransmission DCI. Alternatively, when it is obvious that the PDB of the TB transmitted by the UE expires, for example, when a time point at which the UL grant for the TB is provided is assumed to be a time point at which the TB is generated, if the time-frequency resources for retransmission is to be used only after the PDB of the TB expires, the BS may not transmit the retransmission DCI for the TB to the UE even if decoding of the TB received through a previous transmission fails, and when the time-frequency resources for retransmission are available before the PDB of the TB expires, the BS may transmit the retransmission DCI allocating the time-frequency resources for retransmission to the UE.

According to implementation 3, it is possible for the UE to feedback NACK or ACK even before decoding the PDSCH carrying the TB based on the PDB of the received TB, and thus system delay may be reduced.

According to implementation 3, when the PDB of the related TB expires, the UE may determine that the retransmission DCI is invalid and may not attempt CG PUSCH transmission or SPS PDSCH reception, thereby reducing unnecessary processing or energy consumption in the UE.

### <Implementation 3-1: CG Timer Based on PDB Information>

Implementation 3-1, which operates a CG timer based on the PDB, may be considered in connection with or independently of implementation 3.

The existing CG configuration may include a value of the CG timer. The CG timer is used to prevent the HARQ buffer from being overwritten by new data for an established HARQ process for a configured grant. For example, when the CG timer is not running at the CG occasion, i.e., the transmission occasion according to the CG configuration, the HARQ buffer may be overwritten by new data. When the CG timer for the CG configuration expires and dynamic scheduling for retransmission of a TB associated with a HARQ process based on the CG configuration is not received from the BS, the UE may consider that the previous transmission of the TB is successfully received by the BS and empty the data in the HARQ buffer. When a PDCCH for a UL grant addressed to a C-RNTI or CS-RNTI is received for a configured HARQ process for the configured grant, or when UL transmission is performed for the configured HARQ process for the configured grant, the CG timer may be started or restarted. The CG timer may be stopped upon activation of a Type 2 configured grant such that the HARQ buffer may be refreshed before applying the new configurations. In summary, the existing CG timer operates per HARQ process and is provided per CG configuration, and CG configurations that share the same HARQ process use the same CG timer. While the CG timer is running, new data using other semi-static grants for the HARQ process (e.g., UL grants provided by the CG configuration) may not override the data in the HARQ buffer of the HARQ process.

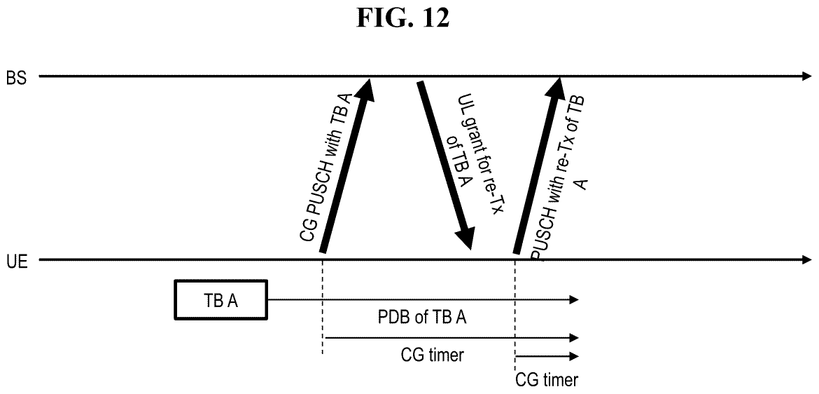

FIG. 12 illustrates a CG timer according to some implementations of the present disclosure.

Referring to FIG. 12, when a UE performs transmission on a PUSCH, the UE may determine a length of the CG timer based on PDB information. Conventionally, the UE determines the length of a CG timer for the HARQ process used for PUSCH transmission based on the CG associated with the HARQ process and restricts use of the CG PUSCH during the corresponding time. However, in this case, an unnecessarily long CG timer may be configured, which may result in the UE not being capable of using the CG PUSCH through the HARQ process even though the actual scheduled PUSCH transmission ends. In consideration of this case, in some implementations of the present disclosure, the remaining PDB length until expiration may be defined as a CG timer based on the PDB information associated with the scheduled PUSCH or the TB transmitted therethrough. In this case, whether the PBD of the previous transmission expires may be determined by whether the CG timer expires. For example, the UE may monitor the retransmission DCI for the TB transmitted over a CG PUSCH while the CG timer is running, and when the retransmission DCI is received before the CG timer expires (or when the PUSCH occasion based on the retransmission DCI is before the CG timer expires), the UE may perform retransmission according to the retransmission DCI. When the CG timer expires before receiving the retransmission DCI or before the PUSCH occasion due to the retransmission DCI, the UE may disregard the retransmission DCI.

When a plurality of CG configurations are given to the UE for one HARQ process, a value of the CG timer may be provided for each CG configuration, and thus it may be difficult to determine the length of the CG timer by determining the length of the CG timer with the value given by the CG configuration associated with the HARQ process. In this case, in some implementations of the present disclosure, the length of the CG timer may be determined with reference to a CG configuration having the lowest configuration index from among a plurality of associated (activated) CG configurations.

According to implementation 3-1, the length of the CG timer is determined based on the PDB of the TB, and thus a problem of CG PUSCH resources associated with the HARQ process used for transmission of the TB being unnecessarily restricted from being used for a long time may be resolved.

According to implementation 3-1, the length of the CG timer is determined based on the remaining PDB of the associated TB, and thus the validity of the retransmission DCI for the TB transmitted through the CG PUSCH may be determined based on the CG timer.

### <Implementation 4: CG Adaptation Based on PDB>

The location of the CG PUSCH is semi-static, and thus when traffic generation of the UE and a start time of the CG PUSCH are misaligned, and thus the UE may need to wait for a next CG PUSCH occasion to transmit the corresponding traffic. In this case, it may be considered that the UE transmits additional information about the CG PUSCH transmission to the BS through the scheduling request, for example, information about the required CG PUSCH resource adjustment, and it may be considered that the BS, upon receiving the resource adjustment, explicitly or implicitly adjusts the CG PUSCH resources.

The additional information may be an offset of the resource start point of CG PUSCH. The UE may determine a value of a preferred resource offset based on traffic arrival. The additional information may indicate the location offset of the preferred PUSCH occasion of the UE in symbol units or slot units. To this end, a plurality of location offsets may be predefined or configured by higher layer signaling (e.g. RRC signaling) of the BS, and one of the location offsets may be transmitted from the UE to the BS. For example, when the additional information is transmitted in a size of several bits (e.g., 2 bits), the size of the offset indicated by each bit representation may be predefined or defined through upper layer signaling of the BS (e.g., RRC signaling). For example, the offset represented by each bit representation may be determined based on each associated RRC parameter configured by the BS, and a range of each RRC parameter value may be −13 to +14 symbols or slots. Alternatively, when an offset is transferred as additional information in 2-bits, bit representations ‘00’, ‘01’, ‘10’, and ‘11’ may be slot offsets of −1, 0, 1, and 2 or slot offsets of 2, −1, 1, and 2, respectively. The former case in which the RRC parameter values range from −13 to +14 symbols may be used when the offset is transmitted using a MAC control element (CE), and the latter case in which the offset is transmitted using additional information of 2-bit may be used when the offset is used in the form of a scheduling request.

Alternatively, the additional information may indicate TDRA information. The UE may request to use PUSCH resources in other locations within a slot as CG resources by transmitting to the BS a TDRA that is preferred over the resources configured in the configured CG PUSCH. In this case, when the additional information is transmitted in the size of several bits (e.g., 2-bit), each bit representation may mean a TDRA index that is preconfigured or predefined by higher layer signaling of the BS.

The additional information may be transmitted via a MAC control element (CE), UCI, or the like. When the additional information is transmitted using the MAC CE, a buffer status report (BSR) may be delivered in the form of a long BSR or a short BSR, including additional information fields. When the additional information is transmitted using the UCI, the additional information may be included in a scheduling request or transmitted using a scheduling request resource.

For example, when another HARQ-ACK is not multiplexed in the existing scheduling request when the additional information is included in the scheduling request, and when the additional information is not indicated, SR transmission is performed as follows in the same manner as before. In the case of positive SR transmission using PUCCH format 0, the UE transmits the PUCCH as described in 3GPP TS 38.211 by obtaining m₀ to set as described for HARQ-ACK information in Section 9.2.3 of 3GPP TS 38.213. In the case of positive SR transmission using PUCCH format 1, the UE transmits the PUCCH as described in 3GPP TS 38.211 by setting b(0)=0.

When the SR resource uses PUCCH format 0 and is capable of transmitting one, two, or three types of additional information together with the SR, the SR PUCCH transmission is performed as follows using cyclic shifts of 6, [4,8], and [3,6,9], respectively. The UE transmits the PUCCH as described in 3GPP TS 38.211 by obtaining m₀ to set m_{cs}=[6], [4,8], [3,6,9] as described for the HARQ-ACK information in Section 9.2.3 of 3GPP TS 38.213.

The cyclic shift sequence [6], [4,8], and [3,6,9] may be used to transmit one of three non-zero additional information, respectively. For example, when the BS configures three non-zero location offsets to the UE, the UE may perform PUCCH transmission by applying a second value m_{cs}=6 from among sequences of [3, 6, 9] as a cyclic shift to transmit a second location offset closest to the location offset of the PUSCH occasion preferred by the UE to the BS.

When the SR resource uses PUCCH format 1, the UE transmits the PUCCH as described in 3GPP TS 38.211 by setting b(0)=1. In this case, the corresponding SR transmission may mean a first value of the additional information to be transmitted.

It may be considered that some SR resources are not configured to notify the UE of UL data as before, but are configured to transmit the additional information. In this case, when the corresponding SR resource uses PUCCH format 1, the UE may transmit the PUCCH as described in 3GPP TS 38.211 by setting b(0)=0 or 1, where 0 may mean a first value of the transmittable additional information and 1 may mean a second value of the transmittable additional information. When the corresponding SR resource uses PUCCH format 0 and is capable of transmitting two, three, or four types of additional information, the SR PUCCH transmission is performed as follows by using cyclic shifts of [0,6], [0,4,8], and [0,3,6,9], respectively. The UE transmits the PUCCH as described in 3GPP TS 38.211 by obtaining m₀ to set m_{cs}=[0,6], [0,4,8], [0,3,6,9] as described for the HARQ-ACK information in Section 9.2.3 of 3GPP TS 38.213.

The cyclic shift sequences [0,6], [0,4,8], [0,3,6,9] may be used to transmit one of two, three, and four additional information, respectively. For example, when the BS configures four location offsets to the UE, the UE may perform PUCCH transmission by applying a second value m_{cs}=3 from among sequences of [0, 3, 6, 9] as a cyclic shift to transmit a second location offset closest to the location offset of the PUSCH occasion preferred by the UE to the BS.

The BS, which receives additional information from the UE, for example, a location offset of a preferred CG PUSCH occasion or a new TDRA, may adjust the location of the CG PUSCH occasion based on the corresponding information. The corresponding offset may be added to the RRC parameter timeDomainOffset in the case of Type-1 CG or may change the location of the PUSCH initially indicated by the activation DCI in the case of Type-2 CG. The UE may assume this change of the PUSCH occasion of the BS and perform CG PUSCH transmission at the PUSCH occasion to be changed after transmitting the additional information. In this case, to make points of time at which locations of PUSCH occasions between the UE and the BS the same, it may be assumed that the PUSCH occasion is changed based on the additional information after a certain symbol length from a symbol in which the additional information is transmitted or after a certain symbol length or slot length from a slot in which the additional information is transmitted. Alternatively, the BS may explicitly indicate or configure the CG PUSCH location based on the additional information transmitted by the UE. For example, to change the location of a Ttype-1 CG PUSCH, the CG configuration obtained by changing timeDomainOffset or the like may be re-configured, and to change the location of a Type-2 CG PUSCH, the CG configuration may be re-activated. Alternatively, a location change in the PUSCH occasion may be re-transmitted to the UE via a MAC CE.

When a start symbol on the time domain of a CG PUSCH occasion changes based on an offset transmitted by the UE, the HARQ process ID determined based on the temporal location of the CG PUSCH resource may also change. This change may cause unnecessary HARQ process collisions, and thus the HARQ process ID may be based on the location of the initially indicated/configured CG PUSCH resource before the offset transmitted by the UE is applied.

### <Implementation 5: Timeline for CG Adaptation>

The BS may change SPS/CG resources and configurations of the UE through the DCI by using a proposed method or a similar method. However, when the UE receives the DCI and changes SPS/CG resources and configurations, the locations of SPS/CG resources, HARQ process IDs associated with each resource, and (in case of SPS) HARQ-ACK transmission locations may change. The UE may need a minimum amount of processing time to change this operation upon receiving the DCI from the BS, and when a timing of this change is not deterministic, i.e. the UE applies this change at a random time, different assumptions may be made about a timing of SPS/CG reception and transmission and SPS HARQ-ACK transmission between the UE and the BS. To this end, at least one of the following may be considered to ensure a minimum processing time for the UE and to make the same assumptions between the BS and the UE.
Opt. 1. When the UE receives the DCI that changes the resource location and configurations of an SPS PDSCH, the UE may not perform HARQ-ACK transmission performed prior to receiving the DCI.
Opt. 2. When the UE receives the DCI that changes the resource location and configurations of an SPS PDSCH, the UE may not receive another SPS PDSCH having the same HARQ process ID as the corresponding SPS PDSCH until the HARQ-ACK transmission of the SPS PDSCH reception performed prior to the reception of the corresponding DCI is terminated.
Op.t 3. This application point in time may be included in, or explicitly indicated or configured in, the DCI that changes the resource location and configurations of the SPS/CG. For example, when the BS changes SPS/CG resources and configurations by using the DCI, the application point in time of the corresponding DCI may be predefined or separately indicated or configured. This application point in time may be given as a relative time location from a reception point in time of the DCI. The corresponding point in time for application may be included in the DCI and transmitted or defined through higher layer signaling of the BS.
Opt. 4. When the UE receives the DCI that changes the resource location and configuration of a CG PUSCH, and the length of the CG timer is changed, the UE may use the CG timer before the change for the PUSCH transmitted before the DCI reception point in time or the DCI application point in time, and apply the CG timer after the change for the PUSCH after the change.

### <Implementation 6: Unused CG Resource Indication>

When the BS indicates and configures one or more CG radio resources to the UE, the UE may selectively use the CG resources according to user data to be transmitted. That is, when there is data to be transmitted, the PUSCH may be transmitted from the CG resource, and when there is no data to be transmitted, the CG PUSCH occasion may be skipped and may not be used. The radio resources are difficult for the BS to reuse, which may reduce the availability of the system. To resolve this problem, a method may be considered in which the UE informs the BS of some of the given CG resources to be actually used, and the BS newly allocates the resources to the UE or another UE for a PUSCH or other purposes, thereby increasing the availability of the system.

For example, when the BS indicates and configures one or more CG radio resources to the UE, the UE notifies the BS of whether to use the configured CG radio resources in the form of L1 signaling or higher layer signaling, and the UE may transmit user data in the CG PUSCH occasion that is notified as being used according to whether there is user data to be transmitted or may skip the corresponding CG PUCSH occasion when there is no user data. The UE may not transmit user data in the CG PUSCH occasion that is not notified as being used or is notified as being unused. That is, in the CG PUSCH occasion that is notified as being unused, the UE may not generate a MAC PDU to be transmitted on the corresponding PUSCH, assume that there is no CG PUSCH occasion, or assume that the CG PUSCH occasion is skipped.

It may be considered that the BS indicates and configures one or more SPS/CG radio resources to the UE, and a plurality of SPS/CG radio resources are allocated for repetitive transmissions of one transport block within a cycle or within a range of a certain period of time.

It may be considered that the BS indicates and configures one or more SPS/CG radio resources to the UE, and a plurality of SPS/CG radio resources for transmission of a plurality of transport blocks are allocated within a cycle or within a range of a certain period of time.

The following may be considered for the UE to inform the BS whether to use the configured CG PUSCH occasion.
Method 1: The UE may indicate whether a CG occasion is used or not through UCI transmitted on the PUSCH in each CG PUCSH occasion or a previous CG PUCSH occasion. For example, when the UE transmits user data on a CG PUSCH, the UE may also transmit the UCI or MAC CE indicating whether to use a next CG occasion or future CG PUSCH occasion. The corresponding UCI or MAC CE may contain 1-bit information indicating whether the next CG PUSCH occasion or future PUSCH occasion is to be used. A BS that receives the corresponding UCI or MAC CE may expect that the UE does not use the radio resources at least for the next CG occasion and may reallocate the radio resources for other purposes. When the UCI indicates whether to use a future PUSCH occasion, the BS may attempt to receive the CG PUSCH occasion of the UE at least when the CG PUSCH occasion is not reallocated, to know when the UE uses a CG PUSCH occasion again.
Method 2: The UE may inform the BS for each CG PUSCH cycle whether to use the CG PUSCH occasion of the corresponding cycle. Alternatively, the UE may inform the BS every N cycles of the CG PUSCH whether to use the CG PUSCH occasion for the current N occasions or the next N occasions. This information may be transmitted in the form of the UCI or MAC CE multiplexed on the PUSCH on a specific CG PUSCH occasion of a period indicating whether to use the CG PUSCH occasion (e.g., a first CG PUSCH occasion in the period) or in the form of a PUCCH carrying at least 1-bit information (e.g., on-off keying) prior to the CG PUSCH occasion indicated by the UE whether the CG PUSCH occasion is used.
   The N CG PUSCH cycles associated with the corresponding information may be N consecutive CG PUSCH cycles including the CG PUSCH occasion X when the information is transmitted in the form of UCI or MAC CE multiplexed on the PUSCH on the CG PUSCH occasion X, N consecutive CG PUSCH cycles after the CG PUSCH occasion X, or N consecutive CG PUSCH cycles after a certain time T from an end time of transmission of the CG PUSCH occasion X.
The N CG PUSCH cycles associated with the corresponding information may be N consecutive CG PUSCH cycles after the PUCCH occasion X when the information is transmitted on a PUCCH X or N consecutive CG PUSCH cycles after a certain time T from an end time of transmission of PUCCH X.
   The certain period of time T may be a value derived from predefined information, a value derived from information provided via L1 signaling or higher layer signaling of the BS, or a value derived from a combination of the information.
   The UE may indicate a first location of the radio resource cycle to be used and the number of radio resource cycles to be used to indicate whether to use the CG PUSCH occasion in K consecutive cycle(s) of N cycles. For example, from among N CG PUSCH cycles, a location S of a first cycle and the number K of cycles of available radio resources may be represented by N*(N+1)/2 state values. In this case, a joint coded information value I may be derived using the following formula.

I=N×(K−1)+S
Method 3: The UE may inform the BS for every N CG PUSCH occasions whether to use the corresponding N CG PUSCH occasions, the next N CG PUSCH occasions, or the next N CG PUSCH occasions of the corresponding N CG PUSCH occasions. This information may be transmitted in the form of UCI or MAC CE multiplexed on the PUSCH in any CG PUSCH occasion or in the form of PUCCH carrying at least 1-bit information (e.g., on-off keying) prior to a first CG PUSCH occasion of a period indicated by the UE whether the corresponding N CG PUSCH occasions are used or not.
   If the information is transmitted in the form of UCI or MAC CE multiplexed on a PUSCH on a CG PUSCH occasion X, the N CG PUSCH occasions associated with the corresponding information may be N consecutive CG PUSCH occasions that include a CG PUSCH occasion X first, N consecutive CG PUSCH occasions after the CG PUSCH occasion X, or N consecutive CG PUSCH occasions after a certain time T from an end time of transmission of the CG PUSCH occasion X.
   If the information is transmitted on a PUCCH X, the N CG PUSCH occasions associated with the corresponding information may be N consecutive CG PUSCH occasions after the PUCCH occasion X or N consecutive CG PUSCH occasions after a certain time T from an end time of transmission of PUCCH X.
   The certain period of time T may be a value derived from predefined information, a value derived from information provided via L1 signaling or higher layer signaling of the BS, or a value derived from a combination of the information.
   The UE may indicate a first location of the radio resource to be used and the number of radio resources to be used to indicate whether to use the CG PUSCH occasion in K consecutive CG PUSCH occasion(s) of N CG PUSCH occasions. For example, from among N CG PUSCH occasions, a location S of a first radio resource and the number K of available radio resources may be represented by N*(N+1)/2 state values. In this case, a joint coded information value I may be derived using the following formula.

I=N×(K−1)+S
Method 4: When the BS provides the CG configuration to the UE, a group of PUSCH occasions within the given CG configuration may be additionally defined. For example, when six CG PUSCH occasions are given in one cycle, first two CG PUSCH occasions may be defined as Group 1, next two CG PUSCH occasions may be defined as Group 2, and next two CG PUSCH occasions may be defined as Group 3. Alternatively, for every 6 cycles, the CG PUSCH occasions during preceding two cycles may be defined as Group 1, the CG PUSCH occasions during next two cycles may be defined as Group 2, and the CG PUSCH occasions during next two cycles may be defined as Group 3. When the UE transmits user data on a CG PUSCH, the UE may also transmit the UCI or MAC CE indicating whether to use a CG PUSCH occasion group to be used for a certain period of time T or in the future. The corresponding UCI or MAC CE may contain X-bit information indicating whether X CG PUSCH occasion groups are to be used. That is, the UE may indicate whether to use a CG PUSCH occasion group to be used for a certain period of time T or in the future through the UCI or the MAC CE at a certain CG PUSCH occasion, and a BS that receives this information may reallocate the CG PUSCH resources that are notified as being unused by the UE for a certain period of time T or until the UE notifies again, for another purpose. When the information indicates whether each CG PUSCH occasion group is to be used during a certain period of time T, then after the certain period of time T, the UE and the BS may assume that all CG PUSCH occasion groups are available.
   The certain period of time T may be a value determined through L1 signaling of BS or higher layer signaling.
   When the X-bit information indicating whether each CG PUSCH occasion group is to be used is transmitted in the form of UCI, the UE may multiplex the corresponding UCI on the PUSCH and transmit the corresponding UCI when transmitting the CG PUSCH, or transmit the corresponding UCI on a separate PUCCH before the CG PUSCH occasion to which the corresponding information is applied.

When implementation 6 is used, it may be considered that the UE may indicate whether to use the CG PUSCH occasion in two separate occasions. For example, a first message may indicate a range of CG PUSCH occasions indicating whether to use the CG PUSCH occasion, and a second message may indicate whether each CG PUSCH occasion is used within the indicated range. In this case, to facilitate blind decoding of the BS, the information of the first message may have a fixed size, and the size of the second message may be considered to be variable depending on a range of the CG PUSCH occasion indicated in the first message. For example, in the first message, K CG PUSCH occasion(s) or K CG PUSCH cycle(s) may be expressed through fixed N-bit information (K<2^{N}), and in the second message, a K-bit bitmap indicating radio resources to be used or not used by the UE during the K CG PUSCH occasion(s) or K CG PUSCH cycle(s) may be transmitted.

When implementation 6 is used, it may be considered that the UE may indicate an application range and whether to use the CG PUSCH occasion in the corresponding range. For example, a message may indicate a range of CG PUSCH occasions that indicate whether to use the CG PUSCH occasion and whether to use the CG PUSCH occasions within the range. In this case, to facilitate blind decoding of the BS, the information of the message may have a fixed size. For example, in a first part of the message, K CG PUSCH occasions or K CG PUSCH cycles may be expressed through N-bit information (K<2^{N}), and in a second part, 1-bit information indicating whether the UE uses radio resources in the corresponding part may be transmitted, and thus a total of N+1 bits of information may be transmitted.

When implementation 6 is used, it may be considered that this operation is performed under an explicit request of the UE. For example, when the CG PUSCH is used, the UE may inform the BS through implementation 6 whether the configured radio resource is used only when the usability of the configured CG PUSCH is low. For the BS to receive information on whether each radio resource notified by the UE is used, the UE may transmit a separate message notifying that the UE uses implementation 6 via L1 signaling or higher layer signaling. The BS that receives the message may assume that information on whether to use the CG PUSCH occasion is included in the CG PUSCH transmission of the UE or in a separately configured PUCCH and may receive the information.

When implementation 6 is used, it may be considered that this operation is performed under an explicit request of the BS. For example, when the UE uses the CG PUSCH, the BS may transmit a separate message to the UE via L1 signaling or higher layer signaling to indicate that the BS uses implementation 6. The UE that receives the message may include information on whether to use the CG PUSCH occasion in the CG PUSCH transmission of the UE or in a separately configured PUCCH, the BS may assume this and receive the information.

The UE may need to have certain capabilities to use the operation described in implementation 6. In this case, the UE may inform the BS of the availability of implementation 6 through a capability report. Upon receiving the capability report, the BS may perform the operation limited to the UE(s) for which implementation 6 is available.

The operation described in implementation 6 may be performed for each CG configuration configured to the UE. For example, whether to use the operation described in implementation 6 may be separately configured for each CG configuration, and the UE may perform implementation 6 for each CG configuration only for the CG configuration that is configured to use implementation 6.

When implementation 6 is used, a BS that does not receive a separate message from a UE and/or a UE that does not transmit a separate message to the BS may assume that all configured CG PUSCH occasion groups are available.

### <Implementation 6-1: UL Multiplexing of Unused CG Resource Indication>

When implementation 6 is used, it may be considered that the UE transmits, to the BS, the UCI X with K-bit information including whether future CG PUSCH occasion(s) is to be used. The UCI Xs may be multiplexed and transmitted on the CG PUSCH, and in this case, a method of multiplexing with other UCIs that need to be transmitted on the PUSCH needs to be considered. In this case, the following method(s) may be considered.
The UCI X may be assumed to be a type of CG-UCI. For example, the UCI X may be multiplexed and treated as the CG-UCI described in 3GPP TS 38.212. When another CG-UCI is already included in the PUSCH, the UCI X may be treated as an additional bit field included in the CG-UCI, and the generated bit sequence of the UCI X may be concatenated with other CG-UCI, and thus the UCI X and the other CG-UCI may be multiplexed as one CG UCI.
   For example, the UCI X may be multiplexed and transmitted with HARQ-ACK. For example, when there is no other HARQ-ACK in the PUSCH, such as the CG-UCI described in 3GPP TS 38.212, the UCI X may be multiplexed separately in the same manner as HARQ-ACK, and when another HARQ-ACK is included in the PUSCH, the UCI X may be jointly coded with the corresponding HARQ-ACK and multiplexed as a single coded bit sequence.
The UCI X may be treated as CSI part 1 and multiplexed on the PUSCH. For example, the UCI X may be treated as the CSI described in 3GPP TS 38.212 or 3GPP TS 38.213, that is, CSI part 1 therefrom and may be multiplexed. When other CSI is already included in the PUSCH, the UCI X may be concatenated with a bit sequence of CSI part 1 of the corresponding CSI and multiplexed as one CSI part 1.
The UCI X may be treated as CSI part 2 and multiplexed on the PUSCH. For example, the UCI X may be treated as the CSI described in 3GPP TS 38.212 or 3GPP TS 38.213, that is, CSI part 2 therefrom and may be multiplexed. When other CSI part 2 is already to be included in the PUSCH, the UE may drop the corresponding CSI part 2 and include the UCI X as a replacement for CSI part 2 or may concatenate a bit sequence of the corresponding CSI part 2 with the UCI X and multiplex the UCI X as one CSI part 2. To this end, CSI part 1 may include an indicator indicating the length of the UCI X.

As another example, when implementation 6 is used, it may be considered that the UE transmits the UCI X with K-bit information including whether future CG PUSCH occasion(s) is to be used, to the BS on a separate PUCCH. In such cases, a method of multiplexing with other UCIs that require transmission on the PUCCH needs to be considered. In this case, the following method(s) may be considered.
The UCI X is treated as a scheduling request (SR) and may be multiplexed within the PUCCH. That is, the UCI X may be multiplexed within the PUCCH in the same way as the SR described in 3GPP TS 38.212 or 3GPP TS 38.213 is transmitted on the PUCCH.
   In this case, when the UCI X is multiplexed with other UCI, the UCI X may be transmitted with a plurality of bit sizes.
   In this case, when only the UCI X is transmitted on the PUCCH without any other UCI, if the UCI X is 2-bit or more, the UCI X may be treated as HARQ-ACK and may be multiplexed in the PUCCH in the same way as the method of transmitting the HARQ-ACK described in 3GPP TS 38.212 or 3GPP TS 38.213 on the PUCCH.
   In this case, when only the UCI X is transmitted on the PUCCH without other UCI, use of the entire CG PUSCH occasion associated with the UCI X may be indicated at once with 1-bit information.

The implementations of the present disclosure described above may be applied individually or in combination of two or more.

According to some implementations of the present disclosure, the BS may dynamically change the radio resources configured for the UE and re-activate previously configured and activated radio resources without packet loss.

While conventionally additional dynamic scheduling is required to enable PUSCH transmission while a CG timer is driven, some implementations of the present disclosure allow the UE to transmit a new packet or terminate previous ongoing transmission on the CG PUSCH to be available through early PDB expiration based on given PDB information without additional signaling from the BS.

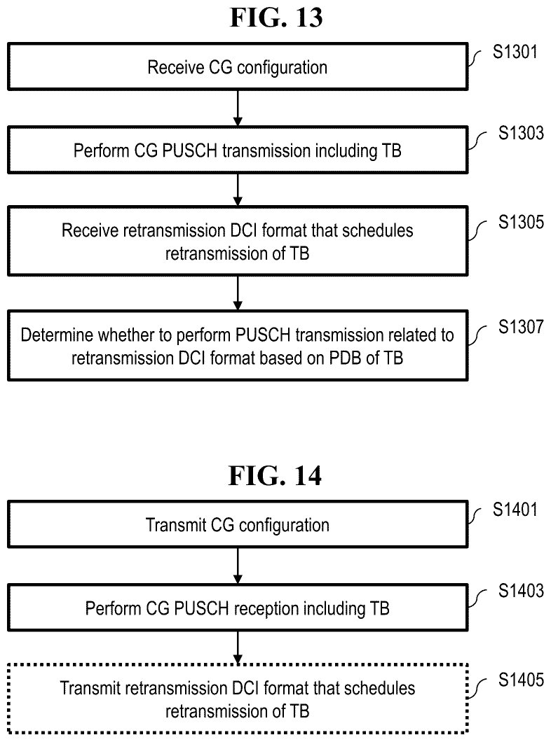

FIG. 13 illustrates a flow of UL signal transmission at a UE according to some implementations of the present disclosure.

The UE may perform operations according to some implementations of the present disclosure in association with uplink signal transmission. The UE may include at least one transceiver; at least one processor; and at least one computer memory operably connectable to the at least one processor and storing instructions that, when executed, cause the at least one processor to perform operations according to some implementations of the present disclosure. A processing device for a UE may include at least one processor; and at least one computer memory operably connectable to the at least one processor and storing instructions that, when executed, cause the at least one processor to perform operations according to some implementations of the present disclosure. A computer readable (non-transitory) storage medium may store at least one computer program including instructions that, when executed by at least one processor, cause the at least one processor to perform operations according to some implementations of the present disclosure. A computer program or a computer program product may include instructions recorded in at least one computer readable (non-transitory) storage medium and causing, when executed, (at least one processor) to perform operations according to some implementations of the present disclosure. The computer program or the computer program product may be recorded in at least one computer-readable (non-transitory) storage medium and may include instructions that, when executed, cause (at least one processor) to perform operations according to some implementations of the present disclosure.

In the method of the UE, the UE, the processing device, the computer-readable (non-volatile) storage medium, and/or the computer program product, the operations may include receiving a configured grant configuration for a configured grant (S1301), performing physical uplink shared channel (PUSCH) transmission including a transport block based on the configured grant (S1305), receiving downlink control information (DCI format) related to the transport block (S1305), and determining whether to perform retransmission according to the DCI format based on whether a packet delay budget of the transport block expires (S1307).

In some implementations, the method or the operations may include performing retransmission for the transport block by using a UL grant included in the DCI format based on that the packet delay budget of the transport block does not expire.

In some implementations, the method or the operations may include disregarding the DCI format based on that the packet delay budget of the transport block expires.

In some implementations, the method or the operations may include determining a length of a configured grant timer for the configured grant based on the packet delay budget of the transport block, and starting the configured grant timer based on performing the PUSCH transmission including the transport block.

In some implementations, the determining of the length of the configured grant timer may include determining a remaining packet delay budget of the transport block as the length of the configured grant timer.

In some implementations, the method or the operations may include determining whether the packet delay budget of the transport block expires based on that the configured grant timer expires.

In some implementations, the method or the operations may include determining that the packet delay budget of the transport block expires based on that the configured grant timer expires.

In some implementations, the method or the operations may include determining that the packet delay budget of the transport block does not expire based on that the configured grant timer is driven.

FIG. 14 illustrates a flow of UL signal reception at a BS according to some implementations of the present disclosure.

The BS may perform operations according to some implementations of the present disclosure in association with uplink signal reception. The BS may include at least one transceiver; at least one processor; and at least one computer memory operably connectable to the at least one processor and storing instructions that, when executed, cause the at least one processor to perform operations according to some implementations of the present disclosure. A processing device for a BS may include at least one processor; and at least one computer memory operably connectable to the at least one processor and storing instructions that, when executed, cause the at least one processor to perform operations according to some implementations of the present disclosure. A computer readable (non-transitory) storage medium may store at least one computer program including instructions that, when executed by at least one processor, cause the at least one processor to perform operations according to some implementations of the present disclosure. A computer program or a computer program product may include instructions recorded in at least one computer readable (non-transitory) storage medium and causing, when executed, (at least one processor) to perform operations according to some implementations of the present disclosure.

In the method of the BS, the BS, the processing device, the computer-readable (non-volatile) storage medium, and/or the computer program product, the operations may include transmitting a configured grant configuration for a configured grant (S1401), and performing physical uplink shared channel (PUSCH) reception including a transport block based on the configured grant (S1403).

In some implementations, the method or the operations may include transmitting or not transmitting downlink control information (DCI format) related to retransmission of the transport block depending on whether a packet delay budget of the transport block expires (S1405).

In some implementations, the DCI format may be transmitted based on that the packet delay budget of the transport block does not expire.

In some implementations, the DCI format may not be transmitted based on that the packet delay budget of the transport block expires.

In some implementations, when the DCI format is transmitted, retransmission of the transport block may or may not be received in the time-frequency resources according to the DCI format depending on whether the packet delay budget of the transport block expires.

In some implementations, retransmission for the transport block in the time-frequency resource may be received based on that the packet delay budget of the transport block does not expire.

In some implementations, retransmission for the transport block in the time-frequency resource may not be received based on that the packet delay budget of the transport block expires.

In some implementations, the method or the operations may include determining a length of a configured grant timer for the configured grant based on the packet delay budget of the transport block, and starting the configured grant timer based on performing the PUSCH reception including the transport block.

In some implementations, the determining of the length of the configured grant timer may include determining a remaining packet delay budget of the transport block as the length of the configured grant timer.

In some implementations, the method or the operations may include determining whether the packet delay budget of the transport block expires based on that the configured grant timer expires.

In some implementations, the method or the operations may include determining that the packet delay budget of the transport block expires based on that the configured grant timer expires.

In some implementations, the method or the operations may include determining that the packet delay budget of the transport block does not expire based on that the configured grant timer is driven.

The examples of the present disclosure as described above have been presented to enable any person of ordinary skill in the art to implement and practice the present disclosure. Although the present disclosure has been described with reference to the examples, those skilled in the art may make various modifications and variations in the example of the present disclosure. Thus, the present disclosure is not intended to be limited to the examples set for the herein, but is to be accorded the broadest scope consistent with the principles and features disclosed herein.

The implementations of the present disclosure may be used in a BS, a UE, or other equipment in a wireless communication system.

1. A method performed by a user equipment (UE) system, the method comprising:
receiving a configured grant configuration for a configured grant;
performing physical uplink shared channel (PUSCH) transmission including a transport block based on the configured grant;
receiving downlink control information (DCI) format related to the transport block; and
determining whether to perform retransmission according to the DCI format based on whether a packet delay budget of the transport block expires.

2. The method of claim 1, further comprising:
performing retransmission for the transport block by using a uplink (UL) grant included in the DCI format based on that the packet delay budget of the transport block does not expire.

3. The method of claim 1, further comprising:
disregarding the DCI format based on that the packet delay budget of the transport block expires.

4. The method of claim 1, further comprising:
determining a length of a configured grant timer for the configured grant based on the packet delay budget of the transport block; and
starting the configured grant timer based on performing the PUSCH transmission including the transport block.

5. The method of claim 4, wherein determining the length of the configured grant timer includes determining a remaining packet delay budget of the transport block as the length of the configured grant timer.

6. The method of claim 4, further comprising:
determining whether the packet delay budget of the transport block expires based on that the configured grant timer expires.

7. A user equipment (UE), the UE comprising:
at least one transceiver;
at least one processor; and
at least one computer memory operably connected to the at least one processor and storing instructions that, when executed, cause the at least one processor to perform operations including:
receiving a configured grant configuration for a configured grant;
performing physical uplink shared channel (PUSCH) transmission including a transport block based on the configured grant;
receiving downlink control information (DCI) format related to the transport block; and
determining whether to perform retransmission according to the DCI format based on whether a packet delay budget of the transport block expires.

8.-10. (canceled)

11. A base station (BS), the BS comprising:
at least one transceiver;
at least one processor; and
at least one computer memory operably connected to the at least one processor and storing instructions that, when executed, cause the at least one processor to perform operations including:
transmitting a configured grant configuration for a configured grant;
performing physical uplink shared channel (PUSCH) reception including a transport block based on the configured grant; and
transmitting downlink control information (DCI) format related to retransmission of the transport block,
wherein, based on whether a packet delay budget of the transport block expires, the retransmission of the transport block is received or not received in a time-frequency resource according to the DCI format.
